(19) United States
(12) Patent Application Publication
(10) Pub. No.: US 2026/0126630 A1
(43) Pub. Date: May 7, 2026

(54) OPTICAL IMAGING SYSTEM

(71) Applicant: Samsung Electro-Mechanics Co., Ltd., Suwon-si (KR)

(72) Inventors: Seong Il CHO, Suwon-si (KR); Hag Chul KIM, Suwon-si (KR); Tae Yeon LIM, Suwon-si (KR); Byung Hyun KIM, Suwon-si (KR)

(73) Assignee: Samsung Electro-Mechanics Co., Ltd., Suwon-si (KR)

(21) Appl. No.: 19/214,755

(22) Filed: May 21, 2025

(30) Foreign Application Priority Data
Nov. 4, 2024 (KR) 10-2024-0154672

(51) Int. Cl. G02B 13/18; G02B 9/62

(52) U.S. Cl. CPC G02B 13/18; G02B 9/62

(57) ABSTRACT

An optical imaging system includes a first lens having a refractive power, a second lens having a negative refractive power, a third lens having a positive refractive power, a fourth lens having a negative refractive power, a fifth lens having a refractive power, and a sixth lens having a refractive power sequentially disposed in ascending numerical order along an optical axis of the optical imaging system from an object side of the optical imaging system toward an imaging plane of the optical imaging system, wherein the conditional conditions 0.85≤TTL/f≤1.0 and 0.5≤f1/f≤1 are satisfied, where TTL is a distance along the optical axis from an object-side surface of the first lens to the imaging plane, f is a total focal length of the optical imaging system, and f1 is a focal length of the first lens.

### CROSS-REFERENCE TO RELATED APPLICATIONS

This application claims the benefit under 35 USC 119 (a) of Korean Patent Application No. 10-2024-0154672 filed on Nov. 4, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

Recently, folded camera modules having a reflective member such as a prism in front of a lens to change a path of incident light are being adopted in portable terminals.

Such folded camera modules can have a longer overall length, so they may be used as telephoto cameras having relatively long focal lengths.

In general, telephoto cameras have a lower resolution than wide-angle cameras and are less effective in low-light environments. These disadvantages are especially evident when capturing images at a high magnification.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a refractive power, a second lens having a negative refractive power, a third lens having a positive refractive power, a fourth lens having a negative refractive power, a fifth lens having a refractive power, and a sixth lens having a refractive power sequentially disposed in ascending numerical order along an optical axis of the optical imaging system from an object side of the optical imaging system toward an imaging plane of the optical imaging system, wherein the conditional expressions 0.85≤TTL/f≤1.0 and 0.5≤f1/f≤1 are satisfied, where TTL is a distance along the optical axis from an object-side surface of the first lens to the imaging plane, f is a total focal length of the optical imaging system, and f1 is a focal length of the first lens.

The third lens may have a concave image-side surface in a paraxial region thereof, and the fourth lens may have a convex object-side surface in a paraxial region thereof.

The first lens and the second lens may be D-cut lenses.

The fifth lens may have a convex image-side surface in a paraxial region thereof, and the sixth lens may have a convex object-side surface in a paraxial region thereof.

The conditional expression 100≤(v1+v3)≤120 may be satisfied, where v1 is an Abbe number of the first lens, and v3 is an Abbe number of the third lens.

The conditional expression 0.8≤R1/R5≤1.2 may be satisfied, where R1 is a radius of curvature of the object-side surface of the first lens at the optical axis, and R5 is a radius of curvature of an object-side surface of the third lens at the optical axis.

The conditional expression 0.2<IMG HT/EPD≤0.4 may be satisfied, where IMG HT is one half of a diagonal length of the imaging plane, and EPD is a diameter of an entrance pupil of the optical imaging system.

The conditional expression 0.2 $ (CT1+CT2+CT3+CT4)/f≤0.5 may be satisfied, where CT1 is a thickness of the first lens along the optical axis, CT2 is a thickness of the second lens along the optical axis, CT3 is a thickness of the third lens along the optical axis, and CT4 is a thickness of the fourth lens along the optical axis.

The conditional expression 0.2≤D45/Td≤0.4 may be satisfied, where D45 is a distance along the optical axis from an image-side surface of the fourth lens to an object-side surface of the fifth lens and Td is a distance along the optical axis from the object-side surface of the first lens to an image-side surface of the sixth lens.

The first lens may be a D-cut lens having a major axis and a minor axis perpendicular to the major axis, and the conditional expression 0.5<AR1<1.0 may be satisfied, where AR1 is equal to a maximum effective radius of an object-side surface of the D-cut lens along the major axis of the D-cut lens to a radius of the object-side surface of the D-cut lens along the minor axis of the D-cut lens.

The conditional expression 0.3<ΣCT/TTL<0.5 may be satisfied, where ΣCT is a sum of thicknesses the first to sixth lenses along the optical axis.

The conditional expression-1.0 V f1/f2<0 may be satisfied, where f2 is a focal length of the second lens.

In another general aspect, an optical imaging system includes a first lens having a refractive power, a second lens having a refractive power, a third lens having a positive refractive power and a concave image-side surface in a paraxial region thereof, a fourth lens having a negative refractive power and a convex object-side surface in a paraxial region thereof, a fifth lens having a refractive power, and a sixth lens having a convex object-side surface in a paraxial region thereof sequentially disposed in ascending numerical order along an optical axis of the optical imaging system from an object side of the optical imaging system toward an imaging plane of the optical imaging system, wherein conditional expressions 1.7<f-number<2.0 and 0.2<IMG HT/EPD≤0.4 are satisfied, where f-number is an f-number of the optical imaging system, IMG HT is one half of a diagonal length of the imaging plane, and EPD is a diameter of an entrance pupil of the optical imaging system.

The first to the sixth lenses may be spaced apart from each other by respective distances along the optical axis, and a distance between the fourth lens and the fifth lens along the optical axis may be greater than each of a distance between the first lens and the second lens along the optical axis, a distance between the second lens and the third lens along the optical axis, a distance between the third lens and the fourth lens along the optical axis, and a distance between the fifth lens and the sixth lens along the optical axis.

The conditional expression 0.2≤D45/Td≤0.4 may be satisfied, where D45 is a distance along the optical axis from an image-side surface of the fourth lens to an object-side surface of the fifth lens, and Td is a distance along the optical axis from an object-side surface of the first lens to an image-side surface of the sixth lens.

The conditional expression 0.8≤R1/R5≤1.2 may be satisfied, where R1 is a radius of curvature of an object-side surface of the first lens at the optical axis, and R5 is a radius of curvature of an object-side surface of the third lens at the optical axis.

The conditional expression 0.2≤(CT1+CT2+CT3+CT4)/f≤0.5 may be satisfied, where CT1 is a thickness of the first lens along the optical axis, CT2 is a thickness of the second lens along the optical axis, CT3 is a thickness of the third lens along the optical axis, CT4 is a thickness of the fourth lens along the optical axis, and f is a total focal length of the optical imaging system.

The optical imaging system may further include an optical path changing member for changing a path of light disposed on an object side of the first lens, wherein one or more of the first lens to the sixth lens may be a D-cut lens.

The fifth lens may have a positive refractive power, and the sixth lens may have a negative refractive power.

The first lens may be a D-cut lens having a major axis and a minor axis perpendicular to the major axis, and the conditional expression 0.5<AR1<1.0 may be satisfied, where AR1 is equal to a maximum effective radius of an object-side surface of the D-cut lens along the major axis of the D-cut lens to a radius of the object-side surface of the D-cut lens along the minor axis of the D-cut lens.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B is a diagram illustrating aberration characteristics of the optical imaging system illustrated in FIG. 1A.

FIG. 2A is a configuration diagram of an optical imaging system according to a second embodiment of the present disclosure.

FIG. 2B is a diagram illustrating aberration characteristics of the optical imaging system illustrated in FIG. 2A.

FIG. 3A is a configuration diagram of an optical imaging system according to a third embodiment of the present disclosure.

FIG. 3B is a diagram illustrating aberration characteristics of the optical imaging system illustrated in FIG. 3A.

FIG. 4A is a configuration diagram of an optical imaging system according to a fourth embodiment of the present disclosure.

FIG. 4B is a diagram illustrating aberration characteristics of the optical imaging system illustrated in FIG. 4A.

FIG. 5A is a configuration diagram of an optical imaging system according to a fifth embodiment of the present disclosure.

FIG. 5B is a diagram illustrating aberration characteristics of the optical imaging system illustrated in FIG. 5A.

FIG. 6A is a configuration diagram of an optical imaging system according to a sixth embodiment of the present disclosure.

FIG. 6B is a diagram illustrating aberration characteristics of the optical imaging system illustrated in FIG. 6A.

FIG. 7A is a configuration diagram of an optical imaging system according to a seventh embodiment of the present disclosure.

FIG. 7B is a diagram illustrating aberration characteristics of the optical imaging system illustrated in FIG. 7A.

FIG. 8A is a configuration diagram of an optical imaging system according to an eighth embodiment of the present disclosure.

FIG. 8B is a diagram illustrating aberration characteristics of the optical imaging system illustrated in FIG. 8A.

FIG. 9A is a configuration diagram of an optical imaging system according to a ninth embodiment of the present disclosure.

FIG. 9B is a diagram illustrating aberration characteristics of the optical imaging system illustrated in FIG. 9A.

FIG. 10 a diagram illustrating an optical imaging system including an optical path changing member.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the optical system configuration diagrams in the drawings, the thickness, size, and shape of a lens may be somewhat exaggerated for clarity of explanation, and in particular, the spherical or aspherical shape of a lens shown in the optical system configuration diagrams is only an example, and is not limited thereto.

In the present specification, a first lens refers to a lens closest to an object side of an optical imaging system, and a sixth lens refers to a lens closest to an imaging plane (or an image sensor) of the optical imaging system.

Additionally, in the present specification, values of a radius of curvature of a lens surface, a thickness of a lens, a distance between lenses or other elements, a focal length of a lens, and other dimensions are expressed in mm.

In addition, in a description of a shape of a lens, a statement that a surface of the lens is convex means that a paraxial region of the surface is convex, and a statement that a surface of the lens is concave means that a paraxial region of the surface is concave.

Accordingly, even when it is stated that a surface of a lens is convex, an edge portion of the surface may be concave. Similarly, even when it is stated that a surface of a lens is concave, an edge portion of the surface may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

In this specification, an effective diameter of a lens surface is a diameter of a portion of the lens surface through which light actually passes, and is equal to twice an effective radius of the lens surface. An object-side surface of a lens and an image-side surface of the lens may have different effective diameters or radiuses.

An optical imaging system according to an embodiment of the present disclosure may include six lenses. For example, an optical imaging system according to an embodiment of the present disclosure may include a first lens, a second lens, a third lens, a fourth lens, a fifth lens, and a sixth lens sequentially disposed in ascending numerical order along an optical axis of the optical imaging system from an object side of the optical imaging system toward an imaging plane of the optical imaging system.

However, the optical imaging system according to an embodiment of the present disclosure may not consist only of six lenses, and may further include other components as needed. For example, the optical imaging system may further include an image sensor for converting incident light from a subject into an electrical signal. In addition, the optical imaging system may further include an infrared blocking filter (hereinafter referred to as a filter) for blocking light within the infrared region from being incident on the image sensor.

Additionally, the optical imaging system may further include a stop for controlling an amount of light passing through the optical imaging system. In addition, the optical imaging system may further include an optical path changing member for changing a path of light. For example, the optical path changing member may be disposed on an object side of the first lens and may be provided as a prism or a mirror, but is not limited thereto.

The optical imaging system may include a lens made of a plastic material. For example, the first to sixth lenses may all be made of a plastic material.

Additionally, at least one lens among the first to sixth lenses may have an aspherical surface. For example, the first to sixth lenses may each have at least one aspherical surface. The aspherical surfaces of the first to sixth lenses are defined by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad Equation 1$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy any one or any combination of any two or more of the conditional expressions below.

$$0.5 < AR 1 < 1. \qquad ( Conditional Expression 1 )$$

$$0.2 < IMG HT / EPD \leq 0.4 \qquad ( Conditional Expression 2 )$$

$$0.2 \leq ( CT 1 + CT 2 + CT 3 + CT 4 ) / f \leq 0.5 \qquad ( Conditional Expression 3 )$$

$$0.85 \leq TTL / f \leq 1. \qquad ( Conditional Expression 4 )$$

$$0.2 \leq D 45 / Td \leq 0.4 \qquad ( Conditional Expression 5 )$$

$$0.5 \leq f 1 / f \leq 1 \qquad ( Conditional Expression 6 )$$

$$100 \leq ( v 1 + v 3 ) \leq 120 \qquad ( Conditional Expression 7 )$$

$$0.8 \leq R 1 / R 5 \leq 1.2 \qquad ( Conditional Expression 8 )$$

$$1.7 < f - number < 2. \qquad ( Conditional Expression 9 )$$

$$0.3 < \sum CT / TTL < 0.5 \qquad ( Conditional Expression 10 )$$

$$- 1. < f 1 / f 2 < 0 \qquad ( Conditional Expression 11 )$$

In Conditional Expression 1, AR1 refers to an aspect ratio of a maximum effective diameter or effective radius of an object-side surface of a first lens along a major axis of the first lens to a diameter or radius of the object-side surface of the first lens along a minor axis of the first lens perpendicular to the major axis of the first lens. Conditional Expression 1 means that the first lens is a D-cut lens including a pair of arc portions and a pair of straight portions extending between the pair of arc portions, and may be a design condition for lowering a module height. A distance between the arc portions is a major axis diameter of the D-cut lens, and is equal to twice a major axis radius of the D-cut lens. A distance between the straight portions is a minor axis diameter of the D-cut lens, and is equal to twice a minor axis diameter of the D-cut lens. The minor axis is perpendicular to the major axis.

In Conditional Expression 2, IMG HT is one half of a diagonal length of an imaging plane of the optical imaging system, and EPD is a diameter of an entrance pupil of the optical imaging system. Conditional Expression 2 is a design condition for lowering an f-number.

In Conditional Expression 3, CT1 is a thickness of the first lens along an optical axis, CT2 is a thickness of the second lens along the optical axis, CT3 is a thickness of the third lens along the optical axis, CT4 is a thickness of the fourth lens along the optical axis, and f is a total focal length of the optical imaging system. Conditional Expression 3 is a design condition for lowering an f-number. According to embodiments of the present disclosure, a low f-number can be implemented relative to a focal length by placing thick lenses in the front portion of the optical imaging system.

In Conditional Expression 4, TTL is a distance along an optical axis from an object-side surface of the first lens to an imaging plane, and f is a total focal length of the optical imaging system. Conditional Expression 4 is a telephoto ratio of the optical imaging system, and if the telephoto ratio is out of the range of Conditional Expressions 4, a telephoto camera performance may not be implemented.

In Conditional Expression 5, D45 is a distance along an optical axis from an image-side surface of the fourth lens to an object-side surface of the fifth lens, and Td is a distance along the optical axis from an object-side surface of the first lens to an image-side surface of the sixth lens. Conditional Expression 5 is a design condition for securing lens performance. According to embodiments of the present disclosure, a front lens group and a rear lens groups are disposed with a sufficient gap therebetween so that an overall performance of the lenses may be implemented evenly.

In Conditional Expression 6, f1 is a focal length of the first lens, and f is an overall focal length of the optical imaging system. Conditional Expression 6 relates to a refractive power of the first lens, and if f/f1 is out of the range of Conditional Expression 6, light rays may not be effectively converged.

In Conditional Expression 7, v1 is an Abbe number of the first lens, and v3 is an Abbe number of the third lens. Conditional Expression 7 is a condition to balancing the Abbe number for effectively correcting chromatic aberration.

In Conditional Expression 8, R1 is a radius of curvature of an object-side surface of the first lens, and R5 is a radius of curvature of an object-side surface of the third lens. Conditional Expression 8 is a lens-shape (radius of curvature) condition for effective ray convergence.

In Conditional Expression 9, f-number is a numerical value representing a brightness of the optical imaging system.

In Conditional Expression 10, ECT is a sum of thicknesses the first to sixth lenses along an optical axis, and TTL is a distance along the optical axis from an object-side surface of the first lens to an imaging plane. Conditional Expression 10 is an appropriate thickness condition for lenses that may effectively correct aberrations while reducing a total length of the optical imaging system.

In Conditional Expression 11, f1 is a focal length of the first lens, and f2 is a focal length of the second lens. Conditional Expression 11 may be related to a performance for correcting chromatic aberration.

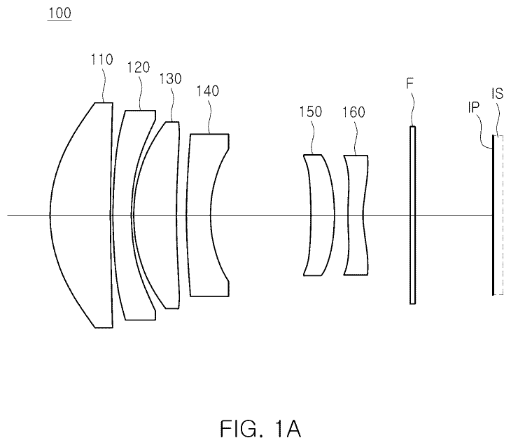

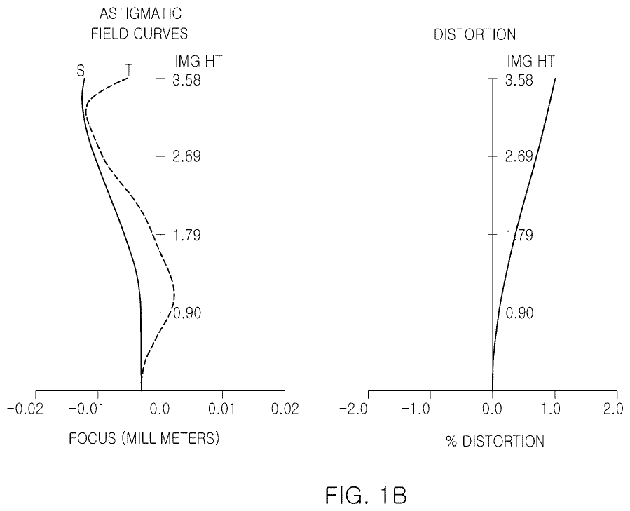

FIG. 1A is a configuration diagram of an optical imaging system according to a first embodiment of the present disclosure, and FIG. 1B is a diagram illustrating aberration characteristics of the optical imaging system illustrated in FIG. 1A.

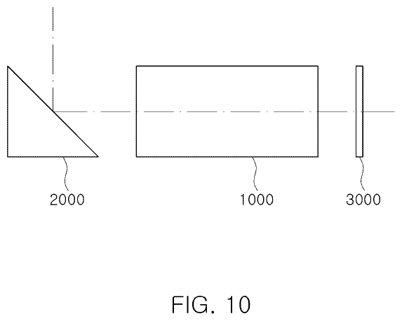

Referring to FIG. 1A, an optical imaging system 100 according to the first embodiment of the present disclosure may include a first lens 110, a second lens 120, a third lens 130, a fourth lens 140, a fifth lens 150, and a sixth lens 160 sequentially disposed from an object side, a filter F, and an image sensor IS having an imaging plane IP on which a focus may be formed. In addition, the optical imaging system 100 may further include an optical path changing member (not shown in FIG. 1A, but see FIG. 10) for changing a path of light disposed on an object side of the first lens 110, and a stop (not shown) disposed on an object side of the fourth lens 140.

A total focal length f of the optical imaging system 100 according to the first embodiment of the present disclosure is 19.410 mm, an IMG HT is 3.584 mm, and an f-number is 1.93.

The characteristics of each element of the optical imaging system 100 according to the first embodiment of the present disclosure are illustrated in Table 1 below.

TABLE 1

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.8628 | 2.5580 | 1.535 | 55.73 | 5.020 | 4.600 |
| S2 | Lens | 105.5609 | 0.1000 | | | 4.847 | 4.600 |
| S3 | 2nd | 26.1326 | 0.7856 | 1.614 | 25.95 | 4.670 | 4.600 |
| S4 | Lens | 9.6771 | 0.1000 | | | 4.263 | 4.600 |
| S5 | 3rd | 7.3930 | 1.8178 | 1.535 | 55.73 | 4.169 | |
| S6 | Lens | 39.9123 | 0.4228 | | | 3.945 | |
| S7 | 4th | 26.8866 | 1.0143 | 1.614 | 25.95 | 3.618 | |
| S8 | Lens | 6.3808 | 4.2601 | | | 2.965 | |
| S9 | 5th | −28.1346 | 1.0013 | 1.671 | 19.24 | 2.606 | |
| S10 | Lens | −9.1160 | 0.5726 | | | 2.700 | |
| S11 | 6th | 11.2663 | 0.6395 | 1.567 | 37.40 | 2.665 | |
| S12 | Lens | 5.1298 | 2.0000 | | | 2.800 | |
| S13 | Filter | Infinity | 0.2100 | 1.518 | 64.17 | 4.000 | |
| S14 | | Infinity | 3.2958 | | | 4.000 | |
| S15 | Imaging | Infinity | | | | | |
| | Plane | | | | | | |

According to the first embodiment of the present disclosure, the first lens 110 may have a positive refractive power, and may have a convex object-side surface and a concave image-side surface. The second lens 120 may have a negative refractive power, and may have a convex object-side surface and a concave image-side surface. The third lens 130 may have a positive refractive power, and may have a convex object-side surface and a concave image-side surface. The fourth lens 140 may have a negative refractive power, and may have a convex object-side surface and a concave image-side surface. The fifth lens 150 may have a positive refractive power, and may have a concave object-side surface and a convex image-side surface. The sixth lens 160 may have a negative refractive power, and may have a convex object-side surface and a concave image-side surface.

According to the first embodiment of the present disclosure, the first lens 110 and the second lens 120 may be D-cut lenses.

Aspherical coefficients of each lens of the optical imaging system 100 according to the first embodiment of the present disclosure are illustrated in Table 2 below. According to the first embodiment of the present disclosure, the first lens 110 to the sixth lens 160 may have aspherical surfaces on both surfaces (the object-side surface and the image-side surface).

TABLE 2

| Surface | | | | | | |
|---|---|---|---|---|---|---|
| No. | S1 | S2 | S3 | S4 | S5 | S6 |
| K | −0.594 | −4.104 | −11.114 | 1.695 | −0.165 | −2.463 |
| A | 4.395E−05 | −3.116E−05 | 1.297E−04 | −2.889E−04 | 9.685E−05 | −5.679E−05 |
| B | 1.863E−05 | −1.821E−07 | 4.395E−06 | 1.262E−05 | 6.532E−06 | −7.146E−06 |
| C | −1.338E−05 | −3.251E−08 | 1.056E−07 | −2.834E−06 | 4.493E−07 | −4.404E−07 |
| D | 5.154E−06 | −1.211E−09 | 1.876E−09 | −1.996E−06 | −1.254E−08 | −1.782E−08 |
| E | −1.298E−06 | 8.817E−11 | −8.184E−11 | 1.900E−06 | −8.371E−10 | 1.234E−10 |
| F | 2.229E−07 | 0.000E+00 | 0.000E+00 | −7.181E−07 | 0.000E+00 | 0.000E+00 |
| G | −2.687E−08 | 0.000E+00 | 0.000E+00 | 1.604E−07 | 0.000E+00 | 0.000E+00 |
| H | 2.309E−09 | 0.000E+00 | 0.000E+00 | −2.354E−08 | 0.000E+00 | 0.000E+00 |
| J | −1.420E−10 | 0.000E+00 | 0.000E+00 | 2.361E−09 | 0.000E+00 | 0.000E+00 |
| L | 6.190E−12 | 0.000E+00 | 0.000E+00 | −1.632E−10 | 0.000E+00 | 0.000E+00 |
| M | −1.868E−13 | 0.000E+00 | 0.000E+00 | 7.664E−12 | 0.000E+00 | 0.000E+00 |
| N | 3.708E−15 | 0.000E+00 | 0.000E+00 | −2.337E−13 | 0.000E+00 | 0.000E+00 |
| O | −4.354E−17 | 0.000E+00 | 0.000E+00 | 4.173E−15 | 0.000E+00 | 0.000E+00 |
| P | 2.290E−19 | 0.000E+00 | 0.000E+00 | −3.314E−17 | 0.000E+00 | 0.000E+00 |

| Surface | | | | | | |
|---|---|---|---|---|---|---|
| No. | S7 | S8 | S9 | S10 | S11 | S12 |
| K | −77.572 | −2.257 | −2.461 | 4.831 | 6.928 | −32.125 |
| A | −1.243E−04 | 9.877E−04 | −7.112E−04 | 5.854E−04 | −1.699E−02 | 1.031E−02 |
| B | 6.911E−06 | 2.120E−05 | −3.658E−04 | −1.081E−04 | 2.281E−03 | −1.361E−02 |
| C | −4.420E−07 | 8.262E−06 | 1.144E−05 | −3.305E−05 | −1.441E−03 | 9.144E−03 |
| D | −6.296E−08 | −1.124E−06 | −3.741E−06 | 1.511E−06 | 1.986E−03 | −4.635E−03 |
| E | 4.353E−09 | 7.073E−08 | 1.209E−07 | 1.298E−08 | −1.954E−03 | 1.664E−03 |
| F | 0.000E+00 | 0.000E+00 | 0.000E+00 | 0.000E+00 | 1.297E−03 | −3.554E−04 |
| G | 0.000E+00 | 0.000E+00 | 0.000E+00 | 0.000E+00 | −5.996E−04 | 9.185E−06 |
| H | 0.000E+00 | 0.000E+00 | 0.000E+00 | 0.000E+00 | 1.966E−04 | 2.157E−05 |
| J | 0.000E+00 | 0.000E+00 | 0.000E+00 | 0.000E+00 | −4.594E−05 | −7.873E−06 |
| L | 0.000E+00 | 0.000E+00 | 0.000E+00 | 0.000E+00 | 7.593E−06 | 1.522E−06 |
| M | 0.000E+00 | 0.000E+00 | 0.000E+00 | 0.000E+00 | −8.671E−07 | −1.836E−07 |
| N | 0.000E+00 | 0.000E+00 | 0.000E+00 | 0.000E+00 | 6.504E−08 | 1.385E−08 |
| O | 0.000E+00 | 0.000E+00 | 0.000E+00 | 0.000E+00 | −2.884E−09 | −6.014E−10 |
| P | 0.000E+00 | 0.000E+00 | 0.000E+00 | 0.000E+00 | 5.727E−11 | 1.150E−11 |

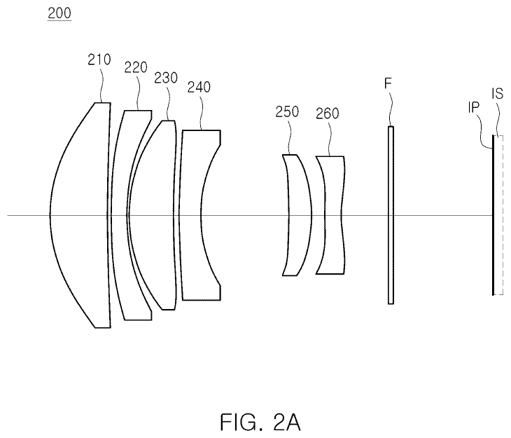

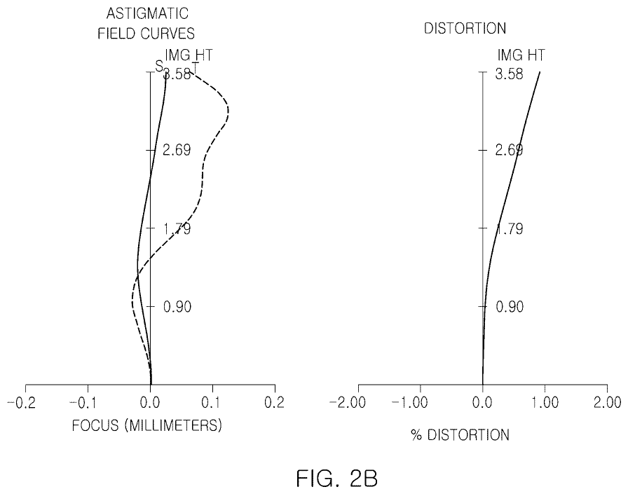

FIG. 2A is a configuration diagram of an optical imaging system according to a second embodiment of the present disclosure, and FIG. 2B is a diagram illustrating aberration characteristics of the optical imaging system illustrated in FIG. 2A.

Referring to FIG. 2A, an optical imaging system 200 according to the second embodiment of the present disclosure may include a first lens 210, a second lens 220, a third lens 230, a fourth lens 240, a fifth lens 250, and a sixth lens 260 sequentially disposed from an object side, a filter F, and an image sensor IS having an imaging plane IP on which a focus may be formed. In addition, the optical imaging system 200 may further include an optical path changing member (not shown in FIG. 2A, but see FIG. 10) for changing a path of light disposed on an object side of the first lens 210, and a stop (not shown) disposed on an object side of the fourth lens 240.

A total focal length f of the optical imaging system 200 according to the second embodiment of the present disclosure is 19.409 mm, an IMG HT is 3.584 mm, and an f-number is 1.93.

The characteristics of each element of the optical imaging system 200 according to the second embodiment of the present disclosure are illustrated in Table 3 below.

TABLE 3

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.8392 | 2.450 | 1.535 | 55.73 | 5.020 | 4.600 |
| S2 | Lens | 76.6739 | 0.159 | | | 4.861 | 4.600 |
| S3 | 2nd | 23.6302 | 0.662 | 1.614 | 25.95 | 4.668 | 4.600 |
| S4 | Lens | 9.6432 | 0.100 | | | 4.309 | 4.600 |
| S5 | 3rd | 7.3700 | 1.874 | 1.535 | 55.73 | 4.218 | |
| S6 | Lens | 38.1775 | 0.244 | | | 4.004 | |
| S7 | 4th | 29.1764 | 0.911 | 1.614 | 25.95 | 3.784 | |
| S8 | Lens | 6.5947 | 3.741 | | | 3.140 | |
| S9 | 5th | −34.1010 | 0.957 | 1.671 | 19.24 | 2.652 | |
| S10 | Lens | −7.8044 | 0.572 | | | 2.700 | |
| S11 | 6th | 18.1151 | 0.695 | 1.614 | 25.95 | 2.629 | |
| S12 | Lens | 5.5590 | 2.000 | | | 2.800 | |
| S13 | Filter | Infinity | 0.210 | 1.518 | 64.17 | 4.000 | |
| S14 | | Infinity | 4.232 | | | 4.000 | |
| S15 | Imaging | Infinity | | | | | |
| | Plane | | | | | | |

According to the second embodiment of the present disclosure, the first lens 210 may have a positive refractive power, and may have a convex object-side surface and a concave image-side surface. The second lens 220 may have a negative refractive power, and may have a convex object-side surface and a concave image-side surface. The third lens 230 may have a positive refractive power, and may have a convex object-side surface and a concave image-side surface. The fourth lens 240 may have a negative refractive power, and may have a convex object-side surface and a concave image-side surface. The fifth lens 250 may have a positive refractive power, and may have a concave object-side surface and a convex image-side surface. The sixth lens 260 may have a negative refractive power, and may have a convex object-side surface and a concave image-side surface.

According to the second embodiment of the present disclosure, the first lens 210 and the second lens 220 may be D-cut lenses.

Aspherical coefficients of each lens of the optical imaging system 200 according to the second embodiment of the present disclosure are illustrated in Table 4 below. According to the second embodiment of the present disclosure, the first lens 210 to the sixth lens 260 may have aspherical surfaces on both surfaces (the object-side surface and the image-side surface).

TABLE 4

| Surface | | | | | | |
|---|---|---|---|---|---|---|
| No. | S1 | S2 | S3 | S4 | S5 | S6 |
| K | −0.598 | −32.428 | −10.805 | 1.701 | −0.161 | −6.669 |
| A | 1.547E−04 | −3.403E−05 | −1.825E−04 | 6.023E−05 | 6.730E−04 | −6.610E−05 |
| B | −1.425E−04 | −4.806E−08 | 1.070E−04 | −3.568E−04 | −1.746E−04 | −7.821E−06 |
| C | 8.431E−05 | −2.909E−08 | −2.156E−05 | 2.538E−04 | 4.582E−05 | −5.139E−07 |
| D | −2.815E−05 | −1.178E−09 | 3.542E−06 | −1.117E−04 | −1.007E−05 | −2.349E−08 |
| E | 5.969E−06 | 8.406E−11 | −3.957E−07 | 3.234E−05 | 1.422E−06 | −2.411E−10 |
| F | −8.620E−07 | 0.000E+00 | 2.820E−08 | −6.514E−06 | −1.175E−07 | 0.000E+00 |
| G | 8.786E−08 | 0.000E+00 | −1.222E−09 | 9.400E−07 | 5.464E−09 | 0.000E+00 |
| H | −6.438E−09 | 0.000E+00 | 2.935E−11 | −9.849E−08 | −1.298E−10 | 0.000E+00 |
| J | 3.408E−10 | 0.000E+00 | −2.993E−13 | 7.502E−09 | 1.173E−12 | 0.000E+00 |
| L | −1.293E−11 | 0.000E+00 | 0.000E+00 | −4.110E−10 | 0.000E+00 | 0.000E+00 |
| M | 3.427E−13 | 0.000E+00 | 0.000E+00 | 1.578E−11 | 0.000E+00 | 0.000E+00 |
| Z | −6.031E−15 | 0.000E+00 | 0.000E+00 | −4.026E−13 | 0.000E+00 | 0.000E+00 |
| O | 6.329E−17 | 0.000E+00 | 0.000E+00 | 6.133E−15 | 0.000E+00 | 0.000E+00 |
| P | −2.998E−19 | 0.000E+00 | 0.000E+00 | −4.220E−17 | 0.000E+00 | 0.000E+00 |
| Surface | | | | | | |
| No. | S7 | S8 | S9 | S10 | S11 | S12 |
| K | −77.898 | −2.541 | −80.000 | 4.110 | −19.456 | −42.389 |
| A | −1.428E−04 | 7.844E−04 | 1.940E−04 | 6.273E−04 | −1.737E−02 | 1.079E−02 |
| B | 5.383E−06 | 3.580E−04 | −1.085E−04 | 4.761E−04 | −4.508E−03 | −2.352E−02 |
| C | −5.332E−07 | −2.162E−04 | −3.216E−04 | −5.492E−04 | 1.002E−02 | 2.709E−02 |
| D | −6.785E−08 | 7.499E−05 | 1.860E−04 | 2.634E−04 | −9.933E−03 | −2.474E−02 |
| E | 4.206E−09 | −1.604E−05 | −6.462E−05 | −8.194E−05 | 6.463E−03 | 1.676E−02 |
| F | 0.000E+00 | 2.178E−06 | 1.337E−05 | 1.596E−05 | −2.884E−03 | −8.225E−03 |
| G | 0.000E+00 | −1.829E−07 | −1.627E−06 | −1.868E−06 | 8.909E−04 | 2.925E−03 |
| H | 0.000E+00 | 8.687E−09 | 1.069E−07 | 1.198E−07 | −1.883E−04 | −7.566E−04 |
| J | 0.000E+00 | −1.782E−10 | −2.913E−09 | −3.236E−09 | 2.592E−05 | 1.420E−04 |
| L | 0.000E+00 | 0.000E+00 | 0.000E+00 | 0.000E+00 | −1.973E−06 | −1.912E−05 |
| M | 0.000E+00 | 0.000E+00 | 0.000E+00 | 0.000E+00 | 1.323E−08 | 1.798E−06 |
| N | 0.000E+00 | 0.000E+00 | 0.000E+00 | 0.000E+00 | 1.224E−08 | −1.121E−07 |
| O | 0.000E+00 | 0.000E+00 | 0.000E+00 | 0.000E+00 | −1.047E−09 | 4.156E−09 |
| P | 0.000E+00 | 0.000E+00 | 0.000E+00 | 0.000E+00 | 2.964E−11 | −6.941E−11 |

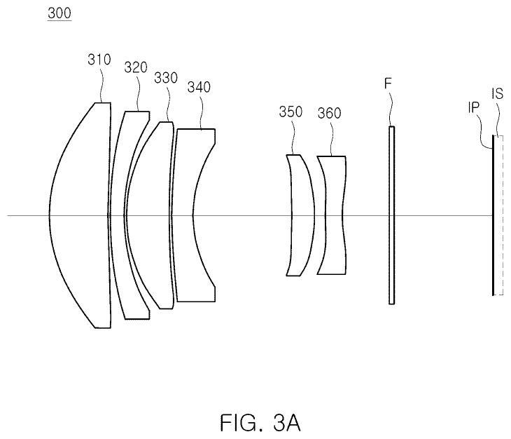

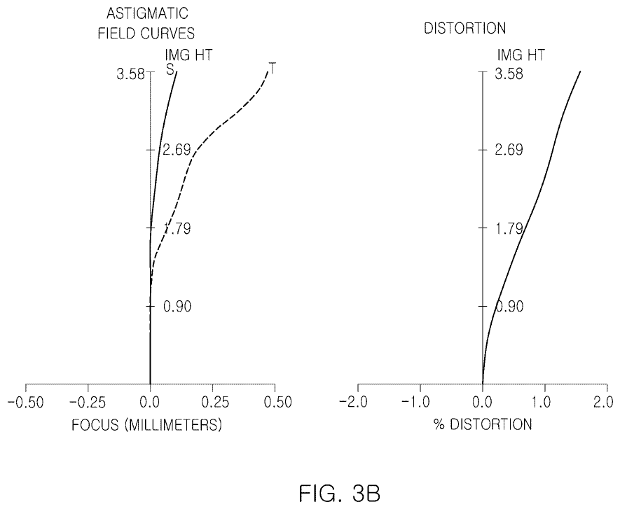

FIG. 3A is a configuration diagram of an optical imaging system according to a third embodiment of the present disclosure, and FIG. 3B is a diagram illustrating aberration characteristics of the optical imaging system illustrated in FIG. 3B.

Referring to FIG. 3A, an optical imaging system 300 according to the third embodiment of the present disclosure may include a first lens 310, a second lens 320, a third lens 330, a fourth lens 340, a fifth lens 350, and a sixth lens 360 sequentially disposed from an object side, a filter F, and an image sensor IS having an imaging plane IP on which a focus may be formed. In addition, the optical imaging system 300 may further include an optical path changing member (not shown in FIG. 3A, but see FIG. 10) for changing a path of light disposed on an object side of the first lens 310, and a stop (not shown) disposed on an object side of the fourth lens 340.

A total focal length f of the optical imaging system 300 according to the third embodiment of the present disclosure is 19.408 mm, an IMG HT is 3.584 mm, and an f-number is 1.93.

The characteristics of each element of the optical imaging system 300 according to the third embodiment of the present disclosure are illustrated in Table 5 below.

TABLE 5

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.9545 | 2.4659 | 1.535 | 55.73 | 5.020 | 4.600 |
| S2 | Lens | 59.0293 | 0.1000 | | | 4.857 | 4.600 |
| S3 | 2nd | 19.5950 | 0.5868 | 1.614 | 25.95 | 4.631 | 4.600 |
| S4 | Lens | 9.4721 | 0.1000 | | | 4.272 | 4.600 |
| S5 | 3rd | 6.9732 | 1.7992 | 1.535 | 55.73 | 4.170 | |
| S6 | Lens | 33.5640 | 0.1084 | | | 3.954 | |
| S7 | 4th | 18.3172 | 0.9150 | 1.614 | 25.95 | 3.849 | |
| S8 | Lens | 5.6168 | 4.1887 | | | 3.201 | |
| S9 | 5th | −37.4772 | 0.9510 | 1.687 | 18.41 | 2.648 | |
| S10 | Lens | −8.4138 | 0.4712 | | | 2.700 | |
| S11 | 6th | 13.8321 | 0.7134 | 1.635 | 23.98 | 2.637 | |
| S12 | Lens | 5.2806 | 2.0000 | | | 2.800 | |
| S13 | Filter | Infinity | 0.2100 | 1.518 | 64.17 | 4.000 | |
| S14 | | Infinity | 4.1966 | | | 4.000 | |
| S15 | Imaging | Infinity | | | | | |
| | Plane | | | | | | |

According to the third embodiment of the present disclosure, the first lens 310 may have a positive refractive power, and may have a convex object-side surface and a concave image-side surface. The second lens 320 may have a negative refractive power, and may have a convex object-side surface and a concave image-side surface. The third lens 330 may have a positive refractive power, and may have a convex object-side surface and a concave image-side surface. The fourth lens 340 may have a negative refractive power, and may have a convex object-side surface and a concave image-side surface. The fifth lens 350 may have a positive refractive power, and may have a concave object-side surface and a convex image-side surface. The sixth lens 360 may have a negative refractive power, and may have a convex object-side surface and a concave image-side surface.

According to the third embodiment of the present disclosure, the first lens 310 and the second lens 320 may be D-cut lenses.

Aspherical coefficients of each lens of the optical imaging system 300 according to the third embodiment of the present disclosure are illustrated in Table 6 below. According to the third embodiment of the present disclosure, the first lens 310 to the sixth lens 360 may have aspherical surfaces on both surfaces (the object-side surface and the image-side surface).

TABLE 6

| Surface | | | | | | |
|---|---|---|---|---|---|---|
| No. | S1 | S2 | S3 | S4 | S5 | S6 |
| K | −0.551 | −73.940 | −8.591 | 1.689 | 0.045 | −12.729 |
| A | 6.494E−04 | −5.047E−05 | −6.303E−04 | −3.667E−03 | −4.697E−03 | −6.110E−04 |
| B | −5.738E−04 | −6.882E−07 | 5.316E−04 | 3.569E−03 | 5.578E−03 | 8.204E−04 |
| C | 2.797E−04 | −5.345E−08 | −1.823E−04 | −1.200E−03 | −2.402E−03 | −4.068E−04 |
| D | −8.175E−05 | −2.175E−09 | 3.559E−05 | 9.341E−05 | 5.260E−04 | 1.027E−04 |
| E | 1.558E−05 | 4.167E−11 | −4.041E−06 | 4.126E−05 | −6.642E−05 | −1.487E−05 |
| F | −2.045E−06 | 0.000E+00 | 2.734E−07 | −1.435E−05 | 5.057E−06 | 1.288E−06 |
| G | 1.907E−07 | 0.000E+00 | −1.089E−08 | 2.339E−06 | −2.297E−07 | −6.601E−08 |
| H | −1.284E−08 | 0.000E+00 | 2.355E−10 | −2.442E−07 | 5.743E−09 | 1.845E−09 |
| J | 6.261E−10 | 0.000E+00 | −2.135E−12 | 1.773E−08 | −6.098E−11 | −2.171E−11 |
| L | −2.188E−11 | 0.000E+00 | 0.000E+00 | −9.132E−10 | 0.000E+00 | 0.000E+00 |
| M | 5.332E−13 | 0.000E+00 | 0.000E+00 | 3.289E−11 | 0.000E+00 | 0.000E+00 |
| N | −8.587E−15 | 0.000E+00 | 0.000E+00 | −7.883E−13 | 0.000E+00 | 0.000E+00 |
| O | 8.183E−17 | 0.000E+00 | 0.000E+00 | 1.128E−14 | 0.000E+00 | 0.000E+00 |
| P | −3.478E−19 | 0.000E+00 | 0.000E+00 | −7.284E−17 | 0.000E+00 | 0.000E+00 |
| Surface | | | | | | |
| No. | S7 | S8 | S9 | S10 | S11 | S12 |
| K | −70.397 | −2.876 | −80.000 | 4.517 | −28.723 | −41.436 |
| A | −1.279E−04 | −4.794E−04 | 7.151E−04 | 1.203E−03 | −1.945E−02 | 1.342E−02 |
| B | 6.709E−06 | 1.304E−03 | 1.319E−03 | −1.957E−05 | 2.848E−04 | −2.466E−02 |
| C | −4.189E−07 | −6.375E−04 | −1.589E−03 | −4.125E−04 | 2.889E−04 | 2.355E−02 |
| D | −5.971E−08 | 1.948E−04 | 7.719E−04 | 2.634E−04 | 9.328E−04 | −1.785E−02 |
| E | 0.000E+00 | −3.841E−05 | −2.282E−04 | −9.147E−05 | −9.773E−04 | 1.045E−02 |
| F | 0.000E+00 | 4.859E−06 | 4.163E−05 | 1.823E−05 | 4.289E−04 | −4.595E−03 |
| G | 0.000E+00 | −3.804E−07 | −4.595E−06 | −2.105E−06 | −7.762E−05 | 1.501E−03 |
| H | 0.000E+00 | 1.673E−08 | 2.794E−07 | 1.310E−07 | −1.091E−05 | −3.625E−04 |
| J | 0.000E+00 | −3.146E−10 | −7.097E−09 | −3.378E−09 | 9.782E−06 | 6.427E−05 |
| L | 0.000E+00 | 0.000E+00 | 0.000E+00 | 0.000E+00 | −2.603E−06 | −8.239E−06 |
| M | 0.000E+00 | 0.000E+00 | 0.000E+00 | 0.000E+00 | 3.885E−07 | 7.415E−07 |
| N | 0.000E+00 | 0.000E+00 | 0.000E+00 | 0.000E+00 | −3.461E−08 | −4.437E−08 |
| O | 0.000E+00 | 0.000E+00 | 0.000E+00 | 0.000E+00 | 1.724E−09 | 1.583E−09 |
| P | 0.000E+00 | 0.000E+00 | 0.000E+00 | 0.000E+00 | −3.712E−11 | −2.546E−11 |

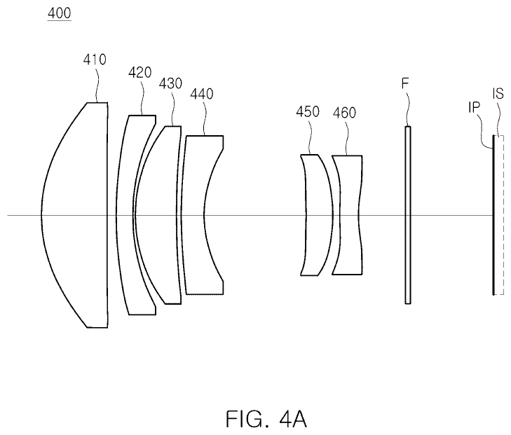

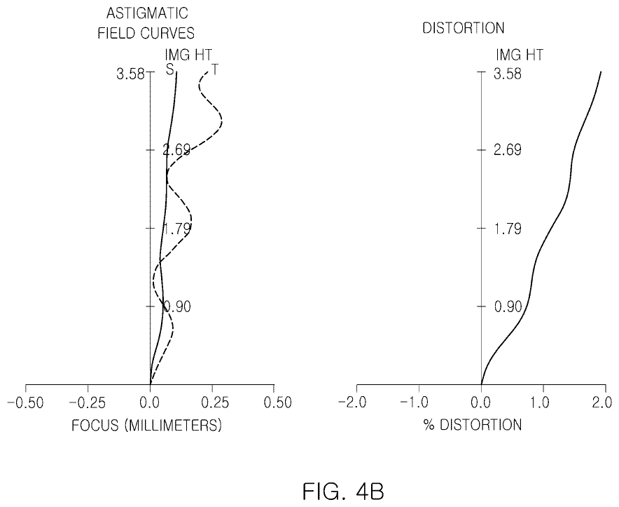

FIG. 4A is a configuration diagram of an optical imaging system according to a fourth embodiment of the present disclosure, and FIG. 4B is a diagram illustrating aberration characteristics of the optical imaging system illustrated in FIG. 4B.

Referring to FIG. 4A, an optical imaging system 400 according to the fourth embodiment of the present disclosure may include a first lens 410, a second lens 420, a third lens 430, a fourth lens 440, a fifth lens 450, and a sixth lens 460 sequentially disposed from an object side, a filter F, and an image sensor IS having an imaging plane IP on which a focus may be formed. In addition, the optical imaging system 400 may further include an optical path changing member (not shown in FIG. 4A, but see FIG. 10) for changing a path of light disposed on an object side of the first lens 410, and a stop (not shown) disposed on an object side of the fourth lens 440.

A total focal length f of the optical imaging system 400 according to the fourth embodiment of the present disclosure is 19.407 mm, an IMG HT is 3.584 mm, and an f-number is 1.93.

The characteristics of each element of the optical imaging system 400 according to the fourth embodiment of the present disclosure are illustrated in Table 7 below.

TABLE 7

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 7.1560 | 2.7402 | 1.535 | 55.73 | 5.020 | 4.600 |
| S2 | Lens | 129.6531 | 0.3946 | | | 4.806 | 4.600 |
| S3 | 2nd | 22.2054 | 0.7024 | 1.614 | 25.95 | 4.458 | 4.600 |
| S4 | Lens | 9.4743 | 0.1069 | | | 4.070 | 4.600 |
| S5 | 3rd | 7.0404 | 1.7380 | 1.535 | 55.73 | 3.964 | |
| S6 | Lens | 35.5370 | 0.2051 | | | 3.682 | |
| S7 | 4th | 18.8859 | 0.9691 | 1.614 | 25.95 | 3.545 | |
| S8 | Lens | 5.4950 | 4.3218 | | | 2.962 | |
| S9 | 5th | −35.2233 | 1.1291 | 1.671 | 19.24 | 2.605 | |
| S10 | Lens | −8.0138 | 0.2940 | | | 2.700 | |
| S11 | 6th | 13.9994 | 0.7766 | 1.614 | 25.95 | 2.653 | |
| S12 | Lens | 5.3302 | 2.0000 | | | 2.800 | |
| S13 | Filter | Infinity | 0.2100 | 1.518 | 64.17 | 4.000 | |
| S14 | | Infinity | 3.5139 | | | 4.000 | |
| S15 | Imaging | Infinity | | | | | |
| | Plane | | | | | | |

According to the fourth embodiment of the present disclosure, the first lens 410 may have a positive refractive power, and may have a convex object-side surface and a concave image-side surface. The second lens 420 may have a negative refractive power, and may have a convex object-side surface and a concave image-side surface. The third lens 430 may have a positive refractive power, and may have a convex object-side surface and a concave image-side surface. The fourth lens 440 may have a negative refractive power, and may have a convex object-side surface and a concave image-side surface. The fifth lens 450 may have a positive refractive power, and may have a concave object-side surface and a convex image-side surface. The sixth lens 460 may have a negative refractive power, and may have a convex object-side surface and a concave image-side surface.

According to the fourth embodiment of the present disclosure, the first lens 410 and the second lens 420 may be D-cut lenses.

Aspherical coefficients of each lens of the optical imaging system 400 according to the fourth embodiment of the present disclosure are illustrated in Table 8 below. According to the fourth embodiment of the present disclosure, the first lens 410 to the sixth lens 460 may have aspherical surfaces on both surfaces (the object-side surface and the image-side surface).

TABLE 8

| Surface | | | | | | |
|---|---|---|---|---|---|---|
| No. | S1 | S2 | S3 | S4 | S5 | S6 |
| K | −0.541 | −78.737 | −8.528 | 1.694 | 0.049 | −0.724 |
| A | 4.304E−04 | −5.088E−05 | −9.472E−04 | −3.340E−03 | −2.791E−03 | −2.036E−06 |
| B | −3.025E−04 | −7.455E−07 | 7.997E−04 | 3.321E−03 | 3.673E−03 | −2.308E−07 |
| C | 1.193E−04 | −5.560E−08 | −2.566E−04 | −1.307E−03 | −1.688E−03 | −2.014E−08 |
| D | −2.814E−05 | −2.231E−09 | 4.546E−05 | 2.304E−04 | 3.873E−04 | 0.000E+00 |
| E | 4.188E−06 | 4.132E−11 | −4.742E−06 | −1.310E−05 | −5.082E−05 | 0.000E+00 |
| F | −3.986E−07 | 0.000E+00 | 2.997E−07 | −2.060E−06 | 4.005E−06 | 0.000E+00 |
| G | 2.299E−08 | 0.000E+00 | −1.131E−08 | 5.141E−07 | −1.880E−07 | 0.000E+00 |
| H | −5.717E−10 | 0.000E+00 | 2.351E−10 | −5.690E−08 | 4.854E−09 | 0.000E+00 |
| J | −2.118E−11 | 0.000E+00 | −2.073E−12 | 4.254E−09 | −5.323E−11 | 0.000E+00 |
| L | 2.526E−12 | 0.000E+00 | 0.000E+00 | −2.432E−10 | 0.000E+00 | 0.000E+00 |
| M | −1.077E−13 | 0.000E+00 | 0.000E+00 | 1.085E−11 | 0.000E+00 | 0.000E+00 |
| N | 2.540E−15 | 0.000E+00 | 0.000E+00 | −3.516E−13 | 0.000E+00 | 0.000E+00 |
| O | −3.282E−17 | 0.000E+00 | 0.000E+00 | 7.140E−15 | 0.000E+00 | 0.000E+00 |
| P | 1.823E−19 | 0.000E+00 | 0.000E+00 | −6.652E−17 | 0.000E+00 | 0.000E+00 |
| Surface | | | | | | |
| No | S7 | S8 | S9 | S10 | S11 | S12 |
| K | −72.737 | −2.728 | −65.611 | 4.421 | −18.281 | −37.977 |
| A | −1.319E−04 | −3.022E−04 | −2.030E−03 | −6.347E−03 | −3.021E−02 | 1.525E−02 |
| B | 6.518E−06 | 1.548E−03 | 4.851E−03 | 1.197E−02 | 2.717E−02 | −4.010E−02 |
| C | −4.290E−07 | −9.567E−04 | −3.877E−03 | −9.401E−03 | −4.073E−02 | 5.817E−02 |
| D | −5.985E−08 | 3.487E−04 | 1.576E−03 | 4.164E−03 | 4.844E−02 | −5.776E−02 |
| E | 3.978E−09 | −7.845E−05 | −3.820E−04 | −1.142E−03 | −4.135E−02 | 3.907E−02 |
| F | 0.000E+00 | 1.103E−05 | 5.450E−05 | 1.967E−04 | 2.489E−02 | −1.845E−02 |
| G | 0.000E+00 | −9.467E−07 | −4.176E−06 | −2.076E−05 | −1.063E−02 | 6.217E−03 |
| H | 0.000E+00 | 4.547E−08 | 1.208E−07 | 1.224E−06 | 3.248E−03 | −1.515E−03 |
| J | 0.000E+00 | −9.390E−10 | 1.305E−09 | −3.083E−08 | −7.126E−04 | 2.677E−04 |
| L | 0.000E+00 | 0.000E+00 | 0.000E+00 | 0.000E+00 | 1.113E−04 | −3.393E−05 |
| M | 0.000E+00 | 0.000E+00 | 0.000E+00 | 0.000E+00 | −1.208E−05 | 3.008E−06 |
| N | 0.000E+00 | 0.000E+00 | 0.000E+00 | 0.000E+00 | 8.661E−07 | −1.769E−07 |
| O | 0.000E+00 | 0.000E+00 | 0.000E+00 | 0.000E+00 | −3.686E−08 | 6.200E−09 |
| P | 0.000E+00 | 0.000E+00 | 0.000E+00 | 0.000E+00 | 7.054E−10 | −9.796E−11 |

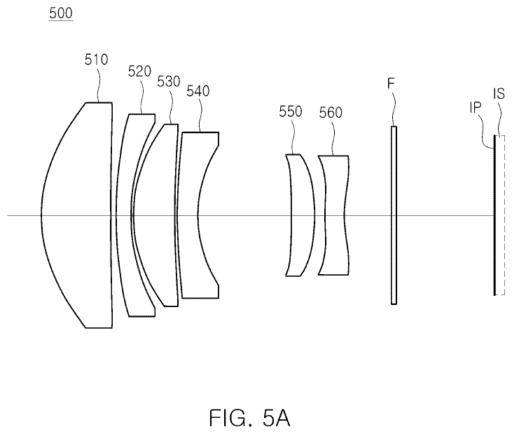

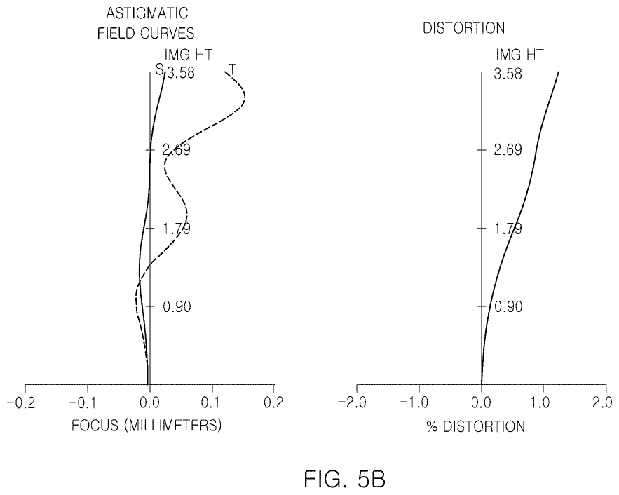

FIG. 5A is a configuration diagram of an optical imaging system according to a fifth embodiment of the present disclosure, and FIG. 5B is a diagram illustrating aberration characteristics of the optical imaging system illustrated in FIG. 5A.

Referring to FIG. 5A, an optical imaging system 500 according to the fifth embodiment of the present disclosure may include a first lens 510, a second lens 520, a third lens 530, a fourth lens 540, a fifth lens 550, and a sixth lens 560 sequentially disposed from an object side, a filter F, and an image sensor IS having an imaging plane IP on which a focus may be formed. In addition, the optical imaging system 500 may further include an optical path changing member (not shown in FIG. 5A, but see FIG. 10) for changing a path of light disposed on an object side of the first lens 510, and a stop (not shown) disposed on an object side of the fourth lens 540.

A total focal length f of the optical imaging system 500 according to the fifth embodiment of the present disclosure is 19.410 mm, an IMG HT is 3.584 mm, and an f-number is 1.93.

The characteristics of each element of the optical imaging system 500 according to the fifth embodiment of the present disclosure are illustrated in Table 9 below.

TABLE 9

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 7.1423 | 2.9261 | 1.535 | 55.73 | 5.020 | 4.600 |
| S2 | Lens | 96.4677 | 0.2164 | | | 4.757 | 4.600 |
| S3 | 2nd | 21.1017 | 0.6447 | 1.614 | 25.95 | 4.501 | 4.600 |
| S4 | Lens | 9.4217 | 0.1110 | | | 4.140 | 4.600 |
| S5 | 3rd | 7.1642 | 1.7379 | 1.535 | 55.73 | 4.050 | |
| S6 | Lens | 40.9263 | 0.1000 | | | 3.822 | |
| S7 | 4th | 19.3733 | 0.8762 | 1.614 | 25.95 | 3.702 | |
| S8 | Lens | 5.6454 | 3.9647 | | | 3.112 | |
| S9 | 5th | −35.8105 | 0.9857 | 1.671 | 19.24 | 2.642 | |
| S10 | Lens | −8.1823 | 0.4311 | | | 2.700 | |
| S11 | 6th | 12.4896 | 0.8125 | 1.614 | 25.95 | 2.643 | |
| S12 | Lens | 5.0753 | 2.000 | | | 2.800 | |
| S13 | Filter | Infinity | 0.2100 | 1.518 | 64.17 | 4.000 | |
| S14 | | Infinity | 4.1466 | | | 4.000 | |
| S15 | Imaging | Infinity | | | | | |
| | Plane | | | | | | |

According to the fifth embodiment of the present disclosure, the first lens 510 may have a positive refractive power, and may have a convex object-side surface and a concave image-side surface. The second lens 520 may have a negative refractive power, and may have a convex object-side surface and a concave image-side surface. The third lens 530 may have a positive refractive power, and may have a convex object-side surface and a concave image-side surface. The fourth lens 540 may have a negative refractive power, and may have a convex object-side surface and a concave image-side surface. The fifth lens 550 may have a positive refractive power, and may have a concave object-side surface and a convex image-side surface. The sixth lens 560 may have a negative refractive power, and may have a convex object-side surface and a concave image-side surface.

According to the fifth embodiment of the present disclosure, the first lens 510 and the second lens 520 may be D-cut lenses.

Aspherical coefficients of each lens of the optical imaging system 500 according to the fifth embodiment of the present disclosure are illustrated in Table 10 below. According to the fifth embodiment of the present disclosure, the first lens 510 to the sixth lens 560 may have aspherical surfaces on both surfaces (the object-side surface and the image-side surface).

TABLE 10

| Surface | | | | | | |
|---|---|---|---|---|---|---|
| No. | S1 | S2 | S3 | S4 | S5 | S6 |
| K | −0.556 | −77.806 | −9.663 | 1.692 | 0.028 | 0.000 |
| A | 3.784E−04 | −4.996E−05 | −1.126E−03 | −3.780E−03 | −2.940E−03 | −8.234E−05 |
| B | −3.042E−04 | −5.303E−07 | 9.879E−04 | 3.538E−03 | 3.699E−03 | −5.260E−06 |
| C | 1.433E−04 | −4.794E−08 | −3.414E−04 | −1.225E−03 | −1.634E−03 | −3.658E−07 |
| D | −4.201E−05 | −2.019E−09 | 6.380E−05 | 1.271E−04 | 3.702E−04 | 0.000E+00 |
| E | 8.228E−06 | 4.636E−11 | −6.967E−06 | 3.208E−05 | −4.887E−05 | 0.000E+00 |
| F | −1.124E−06 | 0.000E+00 | 4.605E−07 | −1.384E−05 | 3.922E−06 | 0.000E+00 |
| G | 1.098E−07 | 0.000E+00 | −1.820E−08 | 2.557E−06 | −1.891E−07 | 0.000E+00 |
| H | −7.788E−09 | 0.000E+00 | 3.969E−10 | −3.023E−07 | 5.050E−09 | 0.000E+00 |
| J | 4.017E−10 | 0.000E+00 | −3.677E−12 | 2.497E−08 | −5.752E−11 | 0.000E+00 |
| L | −1.494E−11 | 0.000E+00 | 0.000E+00 | −1.468E−09 | 0.000E+00 | 0.000E+00 |
| M | 3.902E−13 | 0.000E+00 | 0.000E+00 | 6.033E−11 | 0.000E+00 | 0.000E+00 |
| N | −6.794E−15 | 0.000E+00 | 0.000E+00 | −1.649E−12 | 0.000E+00 | 0.000E+00 |
| O | 7.076E−17 | 0.000E+00 | 0.000E+00 | 2.692E−14 | 0.000E+00 | 0.000E+00 |
| P | −3.333E−19 | 0.000E+00 | 0.000E+00 | −1.985E−16 | 0.000E+00 | 0.000E+00 |
| Surface | | | | | | |
| No. | S7 | S8 | S9 | S10 | S11 | S12 |
| K | −72.770 | −2.830 | −68.735 | 4.262 | −13.431 | −34.292 |
| A | −1.290E−04 | 7.490E−04 | −1.510E−04 | 1.207E−03 | −1.567E−02 | 1.375E−02 |
| B | 6.524E−06 | 2.297E−04 | 2.244E−03 | 3.922E−04 | −2.539E−03 | −2.369−E02 |
| C | −4.440E−07 | −1.395E−04 | −2.245E−03 | −5.480E−04 | 2.861E−03 | 2.540E−02 |
| D | −6.143E−08 | 4.956E−05 | 1.064E−03 | 2.226E−04 | 5.339E−04 | −2.241E−02 |
| E | 4.069E−09 | −1.111E−05 | −3.175E−04 | −5.973E−05 | −2.704E−03 | 1.496E−02 |
| F | 0.000E+00 | 1.583E−06 | 5.999E−05 | 1.077E−05 | 2.381E−03 | −7.327E−03 |
| G | 0.000E+00 | −1.389E−07 | −6.963E−06 | −1.236E−06 | −1.184E−03 | 2.623E−03 |
| H | 0.000E+00 | 6.850E−09 | 4.515E−07 | 8.057E−08 | 3.868E−04 | −6.873E−04 |
| J | 0.000E+00 | −1.451E−10 | −1.250E−08 | −2.249E−09 | −8.704E−05 | 1.314E−04 |
| L | 0.000E+00 | 0.000E+00 | 0.000E+00 | 0.000E+00 | 1.364E−05 | −1.810E−05 |
| M | 0.000E+00 | 0.000E+00 | 0.000E+00 | 0.000E+00 | −1.466E−06 | 1.748E−06 |
| N | 0.000E+00 | 0.000E+00 | 0.000E+00 | 0.000E+00 | 1.034E−07 | −1.121E−07 |
| O | 0.000E+00 | 0.000E+00 | 0.000E+00 | 0.000E+00 | −4.312E−09 | 4.291E−09 |
| P | 0.000E+00 | 0.000E+00 | 0.000E+00 | 0.000E+00 | 8.076E−11 | −7.411E−11 |

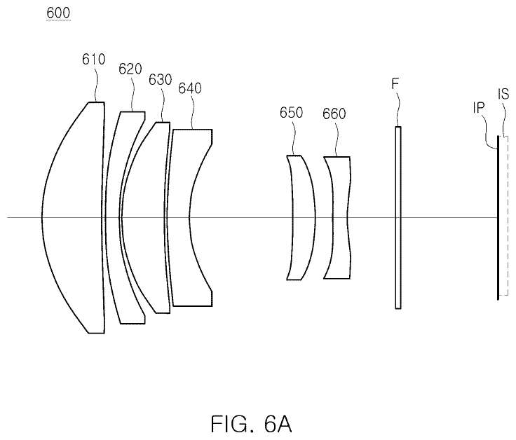

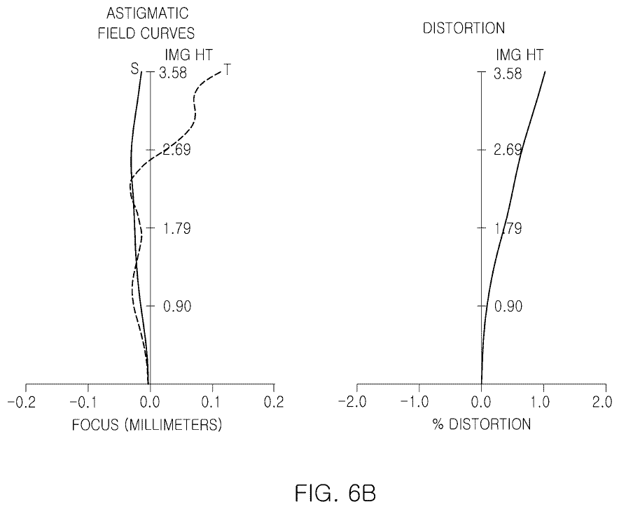

FIG. 6A is a configuration diagram of an optical imaging system according to a sixth embodiment of the present disclosure, and FIG. 6B is a diagram illustrating aberration characteristics of the optical imaging system illustrated in FIG. 6A.

Referring to FIG. 6A, an optical imaging system 600 according to the sixth embodiment of the present disclosure may include a first lens 610, a second lens 620, a third lens 630, a fourth lens 640, a fifth lens 650, and a sixth lens 660 sequentially disposed from an object side, a filter F, and an image sensor IS having an imaging plane IP on which a focus may be formed. In addition, the optical imaging system 600 may further include an optical path changing member (not shown in FIG. 6A, but see FIG. 10) for changing a path of light disposed on an object side of the first lens 610, and a stop (not shown) disposed on an object side of the fourth lens 640.

A total focal length f of the optical imaging system 600 according to the sixth embodiment of the present disclosure is 19.409 mm, an IMG HT is 3.584 mm, and an f-number is 1.93.

The characteristics of each element of the optical imaging system 600 according to the sixth embodiment of the present disclosure are illustrated in Table 11 below.

TABLE 11

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.7960 | 2.4591 | 1.535 | 55.73 | 5.020 | 4.600 |
| S2 | Lens | 56.4911 | 0.1503 | | | 4.858 | 4.600 |
| S3 | 2nd | 19.3293 | 0.5735 | 1.614 | 25.95 | 4.608 | 4.600 |
| S4 | Lens | 9.4713 | 0.1047 | | | 4.265 | 4.600 |
| S5 | 3rd | 6.9336 | 1.7626 | 1.535 | 55.73 | 4.149 | |
| S6 | Lens | 33.1047 | 0.1077 | | | 3.926 | |
| S7 | 4th | 18.1694 | 0.9191 | 1.614 | 25.95 | 3.838 | |
| S8 | Lens | 5.5595 | 4.2749 | | | 3.205 | |
| S9 | 5th | −37.9638 | 0.9268 | 1.671 | 19.24 | 2.638 | |
| S10 | Lens | −8.5301 | 0.7175 | | | 2.700 | |
| S11 | 6th | 14.8392 | 0.6124 | 1.614 | 25.95 | 2.650 | |
| S12 | Lens | 5.4998 | 2.0000 | | | 2.800 | |
| S13 | Filter | Infinity | 0.2100 | 1.518 | 64.17 | 4.000 | |
| S14 | | Infinity | 3.9886 | | | 4.000 | |
| S15 | Imaging | Infinity | | | | | |
| | Plane | | | | | | |

According to the sixth embodiment of the present disclosure, the first lens 610 may have a positive refractive power, and may have a convex object-side surface and a concave image-side surface. The second lens 620 may have a negative refractive power, and may have a convex object-side surface and a concave image-side surface. The third lens 630 may have a positive refractive power, and may have a convex object-side surface and a concave image-side surface. The fourth lens 640 may have a negative refractive power, and may have a convex object-side surface and a concave image-side surface. The fifth lens 650 may have a positive refractive power, and may have a concave object-side surface and a convex image-side surface. The sixth lens 660 may have a negative refractive power, and may have a convex object-side surface and a concave image-side surface.

According to the sixth embodiment of the present disclosure, the first lens 610 and the second lens 620 may be D-cut lenses.

Aspherical coefficients of each lens of the optical imaging system 600 according to the sixth embodiment of the present disclosure are illustrated in Table 12 below. According to the sixth embodiment of the present disclosure, the first lens 610 to the sixth lens 660 may have aspherical surfaces on both surfaces (the object-side surface and the image-side surface).

TABLE 12

| Surface | | | | | | |
|---|---|---|---|---|---|---|
| No. | S1 | S2 | S3 | S4 | S5 | S6 |
| K | −0.551 | −74.704 | −8.294 | 1.678 | 0.036 | −3.932 |
| A | 2.350E−04 | −4.941E−05 | −3.509E−04 | −3.566E−03 | −3.611E−03 | −9.364E−05 |
| B | −1.729E−04 | −7.325E−07 | 3.504E−04 | 3.639E−03 | 4.642E−03 | 7.166E−04 |
| C | 7.764E−05 | −5.818E−08 | −1.288E−04 | −1.509E−03 | −2.071E−03 | −4.560E−04 |
| D | −2.068E−05 | −2.478E−09 | 2.725E−05 | 2.870E−04 | 4.625E−04 | 1.241E−04 |
| E | 3.471E−06 | 2.491E−11 | −3.296E−06 | −1.946E−05 | −5.917E−05 | −1.835E−05 |
| F | −3.801E−07 | 0.000E+00 | 2.341E−07 | −2.447E−06 | 4.549E−06 | 1.590E−06 |
| G | 2.688E−08 | 0.000E+00 | −9.679E−09 | 7.456E−07 | −2.085E−07 | −8.084E−08 |
| H | −1.110E−09 | 0.000E+00 | 2.158E−10 | −9.305E−08 | 5.268E−09 | 2.238E−09 |
| J | 1.258E−11 | 0.000E+00 | −2.006E−12 | 7.449E−09 | −5.662E−11 | −2.615E−11 |
| L | 1.331E−12 | 0.000E+00 | 0.000E+00 | −4.163E−10 | 0.000E+00 | 0.000E+00 |
| M | −8.563E−14 | 0.000E+00 | 0.000E+00 | 1.629E−11 | 0.000E+00 | 0.000E+00 |
| N | 2.449E−15 | 0.000E+00 | 0.000E+00 | −4.264E−13 | 0.000E+00 | 0.000E+00 |
| O | −3.633E−17 | 0.000E+00 | 0.000E+00 | 6.696E−15 | 0.000E+00 | 0.000E+00 |
| P | 2.267E−19 | 0.000E+00 | 0.000E+00 | −4.762E−17 | 0.000E+00 | 0.000E+00 |
| Surface | | | | | | |
| No. | S7 | S8 | S9 | S10 | S11 | S12 |
| K | −71.633 | −2.790 | −66.380 | 4.347 | −29.514 | −46.413 |
| A | −1.253E−04 | 4.892E−04 | 1.455E−03 | 1.704E−03 | −2.009E−02 | 1.145E−02 |
| B | 7.102E−06 | 7.701E−05 | −7.772E−04 | −8.434E−04 | −3.480E−03 | −2.768E−02 |
| C | −3.839E−07 | 1.457E−04 | 2.074E−04 | 5.262E−04 | 8.988E−03 | 3.232E−02 |
| D | −5.683E−08 | −7.454E−05 | −6.861E−05 | −2.301E−04 | −8.168E−03 | −2.936E−02 |
| E | 4.218E−09 | 1.616E−05 | 1.092E−05 | 5.324E−05 | 4.743E−03 | 1.992E−02 |
| F | 0.000E+00 | −1.904E−06 | −1.023E−06 | −7.303E−06 | −1.849E−03 | −9.870E−03 |
| G | 0.000E+00 | 1.253E−07 | 6.563E−08 | 5.944E−07 | 4.728E−04 | 3.561E−03 |
| H | 0.000E+00 | −4.250E−09 | −4.725E−09 | −2.639E−08 | −7.034E−05 | −9.361E−04 |
| J | 0.000E+00 | 5.663E−11 | 2.665E−10 | 4.992E−10 | 2.478E−06 | 1.786E−04 |
| L | 0.000E+00 | 0.000E+00 | 0.000E+00 | 0.000E+00 | 1.272E−06 | −2.444E−05 |
| M | 0.000E+00 | 0.000E+00 | 0.000E+00 | 0.000E+00 | −2.885E−07 | 2.335E−06 |
| N | 0.000E+00 | 0.000E+00 | 0.000E+00 | 0.000E+00 | 2.980E−08 | −1.478E−07 |
| O | 0.000E+00 | 0.000E+00 | 0.000E+00 | 0.000E+00 | −1.599E−09 | 5.563E−09 |
| P | 0.000E+00 | 0.000E+00 | 0.000E+00 | 0.000E+00 | 3.603E−11 | −9.432E−11 |

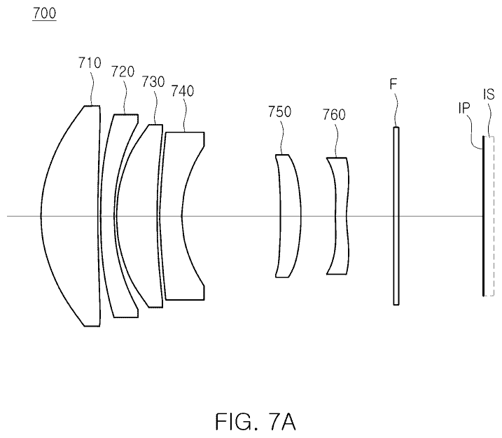

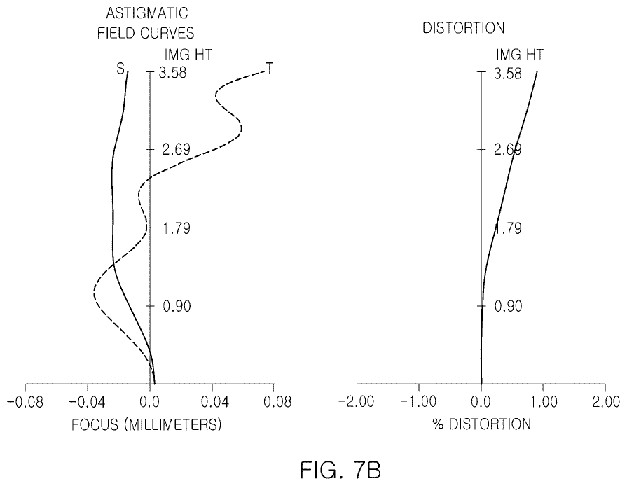

FIG. 7A is a configuration diagram of an optical imaging system according to a seventh embodiment of the present disclosure, and FIG. 7B is a diagram illustrating aberration characteristics of the optical imaging system illustrated in FIG. 7A.

Referring to FIG. 7A, an optical imaging system 700 according to the seventh embodiment of the present disclosure may include a first lens 710, a second lens 720, a third lens 730, a fourth lens 740, a fifth lens 750, and a sixth lens 760 sequentially disposed from an object side, a filter F, and an image sensor IS having an imaging plane IP on which a focus may be formed. In addition, the optical imaging system 700 may further include an optical path changing member (not shown in FIG. 7A, but see FIG. 10) for changing a path of light disposed on an object side of the first lens 710, and a stop (not shown) disposed on an object side of the fourth lens 740.

A total focal length f of the optical imaging system 700 according to the seventh embodiment of the present disclosure is 19.406 mm, an IMG HT is 3.584 mm, and an f-number is 1.97.

The characteristics of each element of the optical imaging system 700 according to the seventh embodiment of the present disclosure are illustrated in Table 13 below.

TABLE 13

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.9898 | 2.4170 | 1.535 | 55.73 | 4.924 | 4.600 |
| S2 | Lens | 71.6400 | 0.1000 | | | 4.762 | 4.600 |
| S3 | 2nd | 21.1004 | 0.5848 | 1.614 | 25.95 | 4.532 | 4.600 |
| S4 | Lens | 9.4835 | 0.1000 | | | 4.197 | 4.600 |
| S5 | 3rd | 6.8126 | 1.7107 | 1.535 | 55.73 | 4.080 | |
| S6 | Lens | 29.2036 | 0.1281 | | | 3.842 | |
| S7 | 4th | 15.7069 | 0.9298 | 1.614 | 25.95 | 3.750 | |
| S8 | Lens | 5.2171 | 4.1740 | | | 3.136 | |
| S9 | 5th | −48.5813 | 0.8802 | 1.671 | 19.24 | 2.650 | |
| S10 | Lens | −9.8908 | 1.4568 | | | 2.740 | |
| S11 | 6th | 14.1785 | 0.4662 | 1.614 | 25.95 | 2.607 | |
| S12 | Lens | 5.9158 | 0.2000 | | | 2.750 | |
| S13 | Filter | Infinity | 0.2100 | 1.518 | 64.17 | 4.000 | |
| S14 | | Infinity | 3.5976 | | | 4.000 | |
| S15 | Imaging | Infinity | | | | | |
| | Plane | | | | | | |

According to the seventh embodiment of the present disclosure, the first lens 710 may have a positive refractive power, and may have a convex object-side surface and a concave image-side surface. The second lens 720 may have a negative refractive power, and may have a convex object-side surface and a concave image-side surface. The third lens 730 may have a positive refractive power, and may have a convex object-side surface and a concave image-side surface. The fourth lens 740 may have a negative refractive power, and may have a convex object-side surface and a concave image-side surface. The fifth lens 750 may have a positive refractive power, and may have a concave object-side surface and a convex image-side surface. The sixth lens 760 may have a negative refractive power, and may have a convex object-side surface and a concave image-side surface.

According to the seventh embodiment of the present disclosure, the first lens 710 and the second lens 720 may be D-cut lenses.

Aspherical coefficients of each lens of the optical imaging system 700 according to the seventh embodiment of the present disclosure are illustrated in Table 14 below. According to the seventh embodiment of the present disclosure, the first lens 710 to the sixth lens 760 may have aspherical surfaces on both surfaces (the object-side surface and the image-side surface).

TABLE 14

| Surface | | | | | | |
|---|---|---|---|---|---|---|
| No. | S1 | S2 | S3 | S4 | S5 | S6 |
| K | −0.567 | −74.630 | −6.777 | 1.647 | 0.017 | −2.395 |
| A | 1.325E−04 | −4.807E−05 | −3.459E−04 | −2.815E−03 | −2.348E−03 | −4.920E−04 |
| B | −9.848E−05 | −8.014E−07 | 4.630E−04 | 1.913E−03 | 1.747E−03 | 2.130E−04 |
| C | 3.600E−05 | −5.988E−08 | −1.581E−04 | −6.993E−04 | −5.799E−04 | −1.026E−05 |
| D | −7.613E−06 | −2.585E−09 | 2.835E−05 | 1.544E−04 | 1.067E−04 | −1.042E−05 |
| E | 9.327E−07 | −1.715E−12 | −2.905E−06 | −2.559E−05 | −1.171E−05 | 2.760E−06 |
| F | −4.518E−08 | 0.000E+00 | 1.776E−07 | 3.858E−06 | 7.812E−07 | −3.185E−07 |
| G | −4.778E−09 | 0.000E+00 | −6.439E−09 | −5.317E−07 | −3.064E−08 | 1.956E−08 |
| H | 1.091E−09 | 0.000E+00 | 1.283E−10 | 5.941E−08 | 6.331E−10 | −6.324E−10 |
| J | −1.007E−10 | 0.000E+00 | −1.088E−12 | −4.955E−09 | −5.038E−12 | 8.617E−12 |
| L | 5.604E−12 | 0.000E+00 | 0.000E+00 | 2.973E−10 | 0.000E+00 | 0.000E+00 |
| M | −2.006E−13 | 0.000E+00 | 0.000E+00 | −1.246E−11 | 0.000E+00 | 0.000E+00 |
| N | 4.540E−15 | 0.000E+00 | 0.000E+00 | 3.466E−13 | 0.000E+00 | 0.000E+00 |
| O | −5.933E−17 | 0.000E+00 | 0.000E+00 | −5.762E−15 | 0.000E+00 | 0.000E+00 |
| P | 3.423E−19 | 0.000E+00 | 0.000E+00 | 4.332E−17 | 0.000E+00 | 0.000E+00 |
| Surface | | | | | | |
| No. | S7 | S8 | S9 | S10 | S11 | S12 |
| K | −65.588 | −2.659 | −80.000 | 4.812 | −42.290 | −55.333 |
| A | −1.149E−04 | 6.532E−04 | 4.239E−04 | 7.453E−04 | −1.808E−02 | 1.119E−02 |
| B | 5.678E−06 | 4.537E−04 | 3.728E−04 | 6.233E−04 | −2.738E−03 | −2.769E−02 |
| C | −4.370E−07 | −2.837E−04 | −5.334E−04 | −5.903E−04 | 3.298E−03 | 2.924E−02 |
| D | −5.585E−08 | 1.075E−04 | 2.406E−04 | 2.283E−04 | 1.839E−03 | −2.295E−02 |
| E | 3.516E−09 | −2.475E−05 | −7.243E−05 | −5.943E−05 | −5.520E−03 | 1.312E−02 |
| F | 0.000E+00 | 3.442E−06 | 1.379E−05 | 9.958E−06 | 4.993E−03 | −5.405E−03 |
| G | 0.000E+00 | −2.841E−07 | −1.608E−06 | −1.028E−06 | −2.645E−03 | 1.609E−03 |
| H | 0.000E+00 | 1.291E−08 | 1.050E−07 | 5.972E−08 | 9.270E−04 | −3.460E−04 |
| J | 0.000E+00 | −2.502E−10 | −2.935E−09 | −1.496E−09 | −2.241E−04 | 5.335E−05 |
| L | 0.000E+00 | 0.000E+00 | 0.000E+00 | 0.000E+00 | 3.770E−05 | −5.784E−06 |
| M | 0.000E+00 | 0.000E+00 | 0.000E+00 | 0.000E+00 | −4.342E−06 | 4.241E−07 |
| N | 0.000E+00 | 0.000E+00 | 0.000E+00 | 0.000E+00 | 3.271E−07 | −1.952E−08 |
| O | 0.000E+00 | 0.000E+00 | 0.000E+00 | 0.000E+00 | −1.453E−08 | 4.833E−10 |
| P | 0.000E+00 | 0.000E+00 | 0.000E+00 | 0.000E+00 | 2.887E−10 | −4.244E−12 |

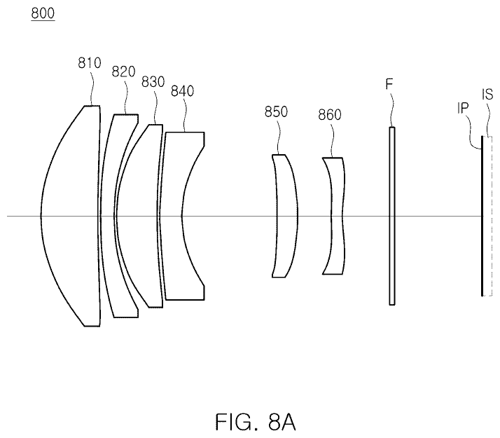

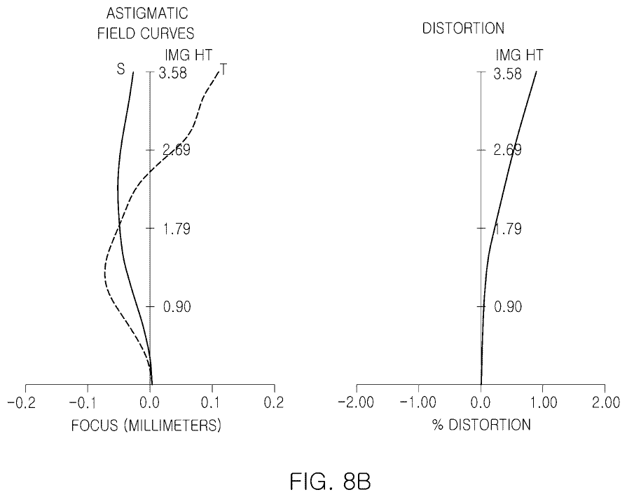

FIG. 8A is a configuration diagram of an optical imaging system according to an eighth embodiment of the present disclosure, and FIG. 8B is a diagram illustrating aberration characteristics of the optical imaging system illustrated in FIG. 8A.

Referring to FIG. 8A, an optical imaging system 800 according to the eighth embodiment of the present disclosure may include a first lens 810, a second lens 820, a third lens 830, a fourth lens 840, a fifth lens 850, and a sixth lens 860 sequentially disposed from an object side, a filter F, and an image sensor IS having and an imaging plane IP on which a focus may be formed. In addition, the optical imaging system 800 may further include an optical path changing member (not shown in FIG. 8A, but see FIG. 10) for changing a path of light disposed on an object side of the first lens 810, and a stop (not shown) disposed on an object side of the fourth lens 840.

A total focal length f of the optical imaging system 800 according to the eighth embodiment of the present disclosure is 19.406 mm, an IMG HT is 3.584 mm, and an f-number is 1.97.

The characteristics of each element of the optical imaging system 800 according to the eighth embodiment of the present disclosure are illustrated in Table 15 below.

TABLE 15

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 6.9888 | 2.4064 | 1.535 | 55.73 | 4.924 | 4.600 |
| S2 | Lens | 64.4664 | 0.1000 | | | 4.772 | 4.600 |
| S3 | 2nd | 20.5323 | 0.6016 | 1.614 | 25.95 | 4.534 | 4.600 |
| S4 | Lens | 9.3668 | 0.1000 | | | 4.193 | 4.600 |
| S5 | 3rd | 6.7565 | 1.7428 | 1.535 | 55.73 | 4.077 | |
| S6 | Lens | 30.2728 | 0.1180 | | | 3.850 | |
| S7 | 4th | 16.1429 | 0.9421 | 1.614 | 25.95 | 3.756 | |
| S8 | Lens | 5.2129 | 3.9837 | | | 3.129 | |
| S9 | 5th | −49.2519 | 0.8907 | 1.671 | 19.24 | 2.661 | |
| S10 | Lens | −9.8995 | 1.4159 | | | 2.725 | |
| S11 | 6th | 14.6358 | 0.4665 | 1.614 | 25.95 | 2.591 | |
| S12 | Lens | 6.0149 | 2.0000 | | | 2.730 | |
| S13 | Filter | Infinity | 0.2100 | 1.518 | 64.17 | 4.000 | |
| S14 | | Infinity | 3.7781 | | | 4.000 | |
| S15 | Imaging | Infinity | | | | | |
| | Plane | | | | | | |

According to the eighth embodiment of the present disclosure, the first lens 810 may have a positive refractive power, and may have a convex object-side surface and a concave image-side surface. The second lens 820 may have a negative refractive power, and may have a convex object-side surface and a concave image-side surface. The third lens 830 may have a positive refractive power, and may have a convex object-side surface and a concave image-side surface. The fourth lens 840 may have a negative refractive power, and may have a convex object-side surface and a concave image-side surface. The fifth lens 850 may have a positive refractive power, and may have a concave object-side surface and a convex image-side surface. The sixth lens 860 may have a negative refractive power, and may have a convex object-side surface and a concave image-side surface.

According to the eighth embodiment of the present disclosure, the first lens 810 and the second lens 820 may be D-cut lenses.

Aspherical coefficients of each lens of the optical imaging system 800 according to the eighth embodiment of the present disclosure are illustrated in Table 16 below. According to the eighth embodiment of the present disclosure, the first lens 810 to the sixth lens 860 may have aspherical surfaces on both surfaces (the object-side surface and the image-side surface).

TABLE 16

| Surface | | | | | | |
|---|---|---|---|---|---|---|
| No. | S1 | S2 | S3 | S4 | S5 | S6 |
| K | −0.569 | −73.214 | −7.102 | 1.647 | 0.022 | −9.044 |
| A | 1.753E−04 | −5.394E−05 | −7.068E−05 | −1.563E−03 | −1.245E−03 | −6.581E−04 |
| B | −1.597E−04 | 3.396E−06 | 1.149E−04 | 6.855E−04 | 1.022E−03 | 7.597E−04 |
| C | 6.331E−05 | 3.143E−06 | −3.349E−05 | −1.748E−04 | −2.680E−04 | −3.059E−04 |
| D | −1.343E−05 | −1.243E−06 | 5.110E−06 | 2.740E−05 | 2.557E−05 | 6.419E−05 |
| E | 1.578E−06 | 1.868E−07 | −2.704E−07 | −6.622E−06 | 7.513E−07 | −8.189E−06 |
| F | −6.819E−08 | −1.518E−08 | −9.253E−09 | 2.102E−06 | −3.682E−07 | 6.672E−07 |
| G | −8.610E−09 | 6.959E−10 | 1.593E−09 | −4.426E−07 | 3.202E−08 | −3.384E−08 |
| H | 1.784E−09 | −1.682E−11 | −6.193E−11 | 5.925E−08 | −1.225E−09 | 9.629E−10 |
| J | −1.581E−10 | 1.652E−13 | 8.092E−13 | −5.318E−09 | 1.802E−11 | −1.160E−11 |
| L | 8.559E−12 | 0.000E+00 | 0.000E+00 | 3.289E−10 | 0.000E+00 | 0.000E+00 |
| M | −2.998E−13 | 0.000E+00 | 0.000E+00 | −1.394E−11 | 0.000E+00 | 0.000E+00 |
| N | 6.663E−15 | 0.000E+00 | 0.000E+00 | 3.883E−13 | 0.000E+00 | 0.000E+00 |
| O | −8.577E−17 | 0.000E+00 | 0.000E+00 | −6.413E−15 | 0.000E+00 | 0.000E+00 |
| P | 4.883E−19 | 0.000E+00 | 0.000E+00 | 4.760E−17 | 0.000E+00 | 0.000E+00 |
| Surface | | | | | | |
| No. | S7 | S8 | S9 | S10 | S11 | S12 |
| K | −68.715 | −2.618 | −80.000 | 4.846 | −50.033 | −57.796 |
| A | −1.222E−04 | 1.363E−03 | 1.307E−03 | 1.047E−03 | −1.792E−02 | 1.135E−02 |
| B | 5.600E−06 | −4.779E−04 | −8.425E−04 | 5.287E−05 | −3.342E−03 | −2.822E−02 |
| C | −4.224E−07 | 2.911E−04 | 3.497E−04 | −1.773E−04 | 4.788E−03 | 2.971E−02 |
| D | −5.345E−08 | −8.616E−05 | −1.486E−04 | 4.758E−05 | −1.031E−03 | −2.374E−02 |
| E | 3.502E−09 | 12.455E−05 | 3.580E−05 | −9.554E−06 | −2.280E−03 | 1.421E−02 |
| F | 0.000E+00 | −1.512E−06 | −5.244E−06 | 1.362E−06 | 2.704E−03 | −6.304E−03 |
| G | 0.000E+00 | 9.562E−08 | 4.473E−07 | −1.299E−07 | −1.566E−03 | 2.070E−03 |
| H | 0.000E+00 | −3.295E−09 | −1.961E−08 | 7.615E−09 | 5.756E−04 | −5.028E−04 |
| J | 0.000E+00 | 4.509E−11 | 3.173E−10 | −2.062E−10 | −1.437E−04 | 8.972E−05 |
| L | 0.000E+00 | 0.000E+00 | 0.000E+00 | 0.000E+00 | 2.477E−05 | −1.158E−05 |
| M | 0.000E+00 | 0.000E+00 | 0.000E+00 | 0.000E+00 | −2.910E−06 | 1.051E−06 |
| N | 0.000E+00 | 0.000E+00 | 0.000E+00 | 0.000E+00 | 2.230E−07 | −6.341E−08 |
| O | 0.000E+00 | 0.000E+00 | 0.000E+00 | 0.000E+00 | −1.005E−08 | 2.284E−09 |
| P | 0.000E+00 | 0.000E+00 | 0.000E+00 | 0.000E+00 | 2.022E−10 | −3.713E−11 |

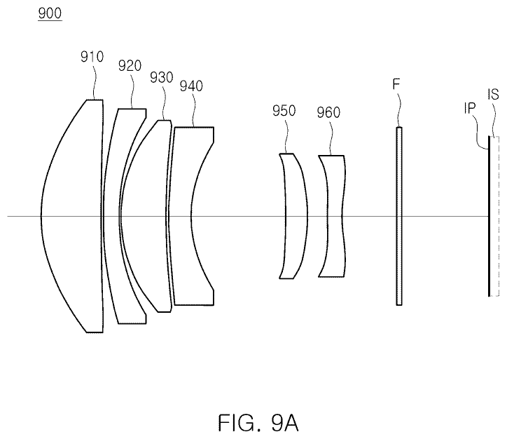

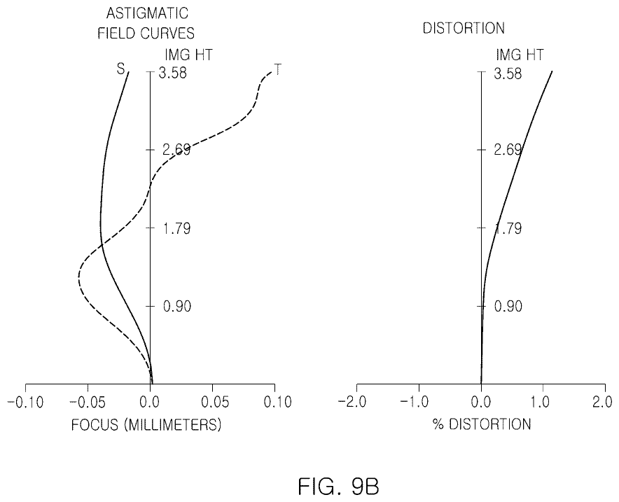

FIG. 9A is a configuration diagram of an optical imaging system according to a ninth embodiment of the present disclosure, and FIG. 9B is a diagram illustrating aberration characteristics of the optical imaging system illustrated in FIG. 9A.

Referring to FIG. 9A, an optical imaging system 900 according to the ninth embodiment of the present disclosure may include a first lens 910, a second lens 920, a third lens 930, a fourth lens 940, a fifth lens 950, and a sixth lens 960 sequentially disposed from an object side, a filter, and an image sensor IS having an imaging plane IP on which a focus may be formed. In addition, the optical imaging system 900 may further include an optical path changing member (not shown in FIG. 9A, but see FIG. 10) for changing a path of light disposed on an object side of the first lens 910, and a stop (not shown) disposed on an object side of the fourth lens 940.

A total focal length f of the optical imaging system 900 according to the ninth embodiment of the present disclosure is 19.409 mm, an IMG HT is 3.584 mm, and an f-number is 1.86.

The characteristics of each element of the optical imaging system 900 according to the ninth embodiment of the present disclosure are illustrated in Table 17 below.

TABLE 17

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | No. | Radius | Radius |
| S1 | 1st | 7.3669 | 2.5342 | 1.535 | 55.73 | 5.200 | 4.600 |
| S2 | Lens | 82.4289 | 0.1000 | | | 5.038 | 4.600 |
| S3 | 2nd | 20.9932 | 0.6730 | 1.614 | 25.95 | 4.795 | 4.600 |
| S4 | Lens | 9.5770 | 0.0800 | | | 4.402 | 4.600 |
| S5 | 3rd | 6.7949 | 1.9002 | 1.535 | 55.73 | 4.286 | |
| S6 | Lens | 30.1293 | 0.1199 | | | 4.066 | |
| S7 | 4th | 18.6406 | 0.9497 | 1.614 | 25.95 | 3.975 | |
| S8 | Lens | 5.7072 | 4.0158 | | | 3.310 | |
| S9 | 5th | −41.2626 | 0.9325 | 1.671 | 19.24 | 2.743 | |
| S10 | Lens | −9.0005 | 0.8416 | | | 2.790 | |
| S11 | 6th | 14.0749 | 0.6270 | 1.614 | 25.95 | 2.713 | |
| S12 | Lens | 5.5968 | 2.0000 | | | 2.860 | |
| S13 | Filter | Infinity | 0.2100 | 1.518 | 64.17 | 4.000 | |
| S14 | | Infinity | 4.0231 | | | 4.000 | |
| S15 | Imaging | Infinity | | | | | |
| | Plane | | | | | | |

According to the ninth embodiment of the present disclosure, the first lens 910 may have a positive refractive power, and may have a convex object-side surface and a concave image-side surface. The second lens 920 may have a negative refractive power, and may have a convex object-side surface and a concave image-side surface. The third lens 930 may have a positive refractive power, and may have a convex object-side surface and a concave image-side surface. The fourth lens 940 may have a negative refractive power, and may have a convex object-side surface and a concave image-side surface. The fifth lens 950 may have a positive refractive power, and may have a concave object-side surface and a convex image-side surface. The sixth lens 960 may have a negative refractive power, and may have a convex object-side surface and a concave image-side surface.

According to the ninth embodiment of the present disclosure, the first lens 910 and the second lens 920 may be D-cut lenses.

Aspherical coefficients of each lens of the optical imaging system 900 according to the ninth embodiment of the present disclosure are illustrated in Table 18 below. According to the ninth embodiment of the present disclosure, the first lens 910 to the sixth lens 960 may have aspherical surfaces on both surfaces (the object-side surface and the image-side surface).

TABLE 18

| Surface | | | | | | |
|---|---|---|---|---|---|---|
| No. | S1 | S2 | S3 | S4 | S5 | S6 |
| K | −0.568 | −64.828 | −8.529 | 1.686 | 0.056 | −9.851 |
| A | 5.426E−05 | −4.231E−05 | −7.615E−05 | −2.863E−03 | −2.659E−03 | 9.095E−04 |
| B | −6.537E−05 | −5.644E−07 | 1.649E−04 | 2.713E−03 | 3.249E−03 | −2.272E−04 |
| C | 2.775E−05 | −4.409E−08 | −6.955E−05 | −1.157E−03 | −1.391E−03 | −3.041E−05 |
| D | −4.541E−06 | −1.761E−09 | 1.564E−05 | 2.617E−04 | 2.995E−04 | 1.732E−05 |
| E | 1.721E−08 | 1.831E−11 | −1.896E−06 | −3.772E−05 | −3.714E−05 | −2.602E−06 |
| F | 1.175E−07 | 0.000E+00 | 1.312E−07 | 4.284E−06 | 2.785E−06 | 1.936E−07 |
| G | −2.256E−08 | 0.000E+00 | −5.214E−09 | −4.653E−07 | −1.252E−07 | −7.675E−09 |
| H | 2.328E−09 | 0.000E+00 | 1.110E−10 | 4.718E−08 | 3.121E−09 | 1.510E−10 |
| J | −1.546E−10 | 0.000E+00 | −9.821E−13 | −3.821E−09 | −3.323E−11 | −1.125E−12 |
| L | 6.913E−12 | 0.000E+00 | 0.000E+00 | 2.237E−10 | 0.000E+00 | 0.000E+00 |
| M | −2.080E−13 | 0.000E+00 | 0.000E+00 | −8.999E−12 | 0.000E+00 | 0.000E+00 |
| N | 4.050E−15 | 0.000E+00 | 0.000E+00 | 2.360E−13 | 0.000E+00 | 0.000E+00 |
| O | −4.620E−17 | 0.000E+00 | 0.000E+00 | −3.643E−15 | 0.000E+00 | 0.000E+00 |
| P | 2.348E−19 | 0.000E+00 | 0.000E+00 | 2.514E−17 | 0.000E+00 | 0.000E+00 |
| Surface | | | | | | |
| No. | S7 | S8 | S9 | S10 | S11 | S12 |
| K | −70.081 | −2.820 | −80.000 | 4.411 | −30.844 | −44.525 |
| A | −1.113E−04 | −3.703E−04 | 1.765E−03 | 1.103E−03 | −1.704E−02 | 1.147E−02 |
| B | 5.849E−06 | 1.096E−03 | −1.219E−03 | 2.449E−05 | −1.874E−03 | −2.324E−02 |
| C | −3.164E−07 | −4.758E−04 | 5.504E−04 | −4.419E−05 | 4.121E−03 | 2.421E−02 |
| D | −4.282E−08 | 1.361E−04 | −1.885E−04 | 9.860E−07 | −2.003E−03 | −1.970E−02 |
| E | 2.762E−09 | −2.628E−05 | 3.426E−05 | −5.829E−06 | −2.998E−04 | 1.201E−02 |
| F | 0.000E+00 | 3.284E−06 | −3.363E−06 | 2.276E−06 | 9.532E−04 | −5.392E−03 |
| G | 0.000E+00 | −2.517E−07 | 1.361E−07 | −3.559E−07 | −6.145E−04 | 1.780E−03 |
| H | 0.000E+00 | 1.071E−08 | 2.231E−09 | 2.622E−08 | 2.289E−04 | −4.319E−04 |
| J | 0.000E+00 | −1.930E−10 | −2.459E−10 | −7.535E−10 | −5.618E−05 | 7.656E−05 |
| L | 0.000E+00 | 0.000E+00 | 0.000E+00 | 0.000E+00 | 9.389E−06 | −9.780E−06 |
| M | 0.000E+00 | 0.000E+00 | 0.000E+00 | 0.000E+00 | −1.061E−06 | 8.753E−07 |
| N | 0.000E+00 | 0.000E+00 | 0.000E+00 | 0.000E+00 | 7.783E−08 | −5.201E−08 |
| O | 0.000E+00 | 0.000E+00 | 0.000E+00 | 0.000E+00 | −3.347E−09 | 1.842E−09 |
| P | 0.000E+00 | 0.000E+00 | 0.000E+00 | 0.000E+00 | 6.410E−11 | −2.942E−11 |

Table 19 below illustrates focal lengths of the first to sixth lenses of the optical imaging system according to the first to ninth embodiments of the present disclosure, and Table 20 below illustrates conditional expression values of the optical imaging system according to the first to ninth embodiments of the present disclosure.

TABLE 19

| | 1st | 2nd | 3rd | 4th | 5th |
|---|---|---|---|---|---|
| Focal | Embodi- | Embodi- | Embodi- | Embodi- | Embodi- |
| Length | ment | ment | ment | ment | ment |
| f1 | 13.602 | 13.871 | 14.501 | 14.053 | 14.260 |
| f2 | −25.474 | −27.000 | −30.514 | −27.470 | −28.297 |
| f3 | 16.642 | 16.723 | 16.079 | 16.075 | 15.953 |
| f4 | −13.877 | −14.083 | −13.556 | −12.970 | −13.289 |
| f5 | 19.689 | 14.871 | 15.592 | 15.213 | 15.588 |
| f6 | −17.256 | −13.333 | −13.903 | −14.503 | −14.520 |

| Focal | 6th | 7th | 8th | 9th |
|---|---|---|---|---|
| Length | Embodiment | Embodiment | Embodiment | Embodiment |
| f1 | 14.629 | 14.297 | 14.446 | 14.951 |
| f2 | −30.908 | −28.582 | −28.619 | −29.319 |
| f3 | 16.024 | 16.184 | 15.854 | 15.953 |
| f4 | −13.409 | −13.157 | −12.955 | −13.772 |
| f5 | 16.198 | 18.543 | 18.305 | 16.965 |
| f6 | −14.586 | −16.883 | −16.969 | −15.560 |

TABLE 20

| Conditional | 1st | 2nd | 3rd |
|---|---|---|---|
| Expression | Embodiment | Embodiment | Embodiment |
| AR1 | 0.916 | 0.916 | 0.916 |
| IMG HT/EPD | 0.357 | 0.357 | 0.357 |
| (CT1 + CT2 + CT3 + CT4)/f | 0.318 | 0.304 | 0.297 |
| TTL/f | 0.967 | 0.969 | 0.969 |
| D45/Td | 0.321 | 0.303 | 0.338 |
| f1/f | 0.701 | 0.715 | 0.747 |
| v1 + v3 | 111.461 | 111.461 | 111.461 |
| R1/R5 | 0.928 | 0.928 | 0.997 |
| f-number | 1.93 | 1.93 | 1.93 |
| ΣCT/TTL | 0.416 | 0.401 | 0.395 |
| f1/f2 | −0.534 | −0.514 | −0.475 |
| Conditional | 4th | 5th | 6th |
| Expression | Embodiment | Embodiment | Embodiment |
| AR1 | 0.916 | 0.916 | 0.916 |
| IMG HT/EPD | 0.357 | 0.357 | 0.357 |
| (CT1 + CT2 + CT3 + CT4)/f | 0.317 | 0.319 | 0.294 |
| TTL/f | 0.984 | 0.987 | 0.969 |
| D45/Td | 0.323 | 0.310 | 0.339 |
| f1/f | 0.724 | 0.735 | 0.754 |
| v1 + v3 | 111.461 | 111.461 | 111.461 |
| R1/R5 | 1.016 | 0.997 | 1.006 |
| f-number | 1.93 | 1.93 | 1.93 |
| ΣCT/TTL | 0.422 | 0.417 | 0.386 |
| f1/f2 | −0.512 | −0.501 | −0.473 |
| Conditional | 7th | 8th | 9th |
| Expression | Embodiment | Embodiment | Embodiment |
| AR1 | 0.934 | 0.934 | 0.885 |
| IMG HT/EPD | 0.364 | 0.364 | 0.345 |
| (CT1 + CT2 + CT3 + CT4)/f | 0.291 | 0.293 | 0.312 |
| TTL/f | 0.966 | 0.966 | 0.979 |
| D45/Td | 0.322 | 0.312 | 0.314 |
| f1/f | 0.737 | 0.744 | 0.770 |
| v1 + v3 | 111.461 | 111.461 | 111.461 |
| R1/R5 | 1.026 | 1.034 | 1.084 |
| f-number | 1.97 | 1.86 | 1.86 |
| ΣCT/TTL | 0.373 | 0.376 | 0.401 |
| f1/f2 | −0.500 | −0.505 | −0.510 |

FIG. 10 a diagram illustrating an optical imaging system including an optical path changing member.

Referring to FIG. 10, an optical imaging system may include an imaging lens system 1000 including first to sixth lenses according to any of the first to ninth embodiments of the present disclosure, an optical path changing member 2000, and an image sensor 3000. The optical path changing member 2000 may change a path of light incident onto the imaging lens system 1000, and may be disposed on an object side of the first lens of the imaging lens system 1000. The image sensor 3000 may be disposed on an image side of the sixth lens of the optical imaging system of FIG. 10.

FIG. 10 shows the optical path changing member 2000 provided as a prism. However, the optical path changing member 2000 is not limited to a prism, but may be provided as a mirror, for example.

The optical imaging system of FIG. 10 may also include a filter (not shown in FIG. 10, but see FIGS. 1A, 2A, 3A, 4A, 5A, 6A, 7A, 8A, and 9A) disposed between the imaging lens system 1000 and the image sensor 3000.

According to the optical imaging system according to embodiments of the present disclosure, a brightness and a resolution of an image captured by a high-magnification telephoto camera may be improved.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having a refractive power, a second lens having a negative refractive power, a third lens having a positive refractive power, a fourth lens having a negative refractive power, a fifth lens having a refractive power, and a sixth lens having a refractive power sequentially disposed in ascending numerical order along an optical axis of the optical imaging system from an object side of the optical imaging system toward an imaging plane of the optical imaging system,
wherein the following conditional expressions are satisfied:
$$0.85 \leq TTL / f \leq 1.$$
$$0.5 \leq f 1 / f \leq 1$$
where TTL is a distance along the optical axis from an object-side surface of the first lens to the imaging plane, f is a total focal length of the optical imaging system, and f1 is a focal length of the first lens.

2. The optical imaging system of claim 1, wherein the third lens has a concave image-side surface in a paraxial region thereof, and the fourth lens has a convex object-side surface in a paraxial region thereof.

3. The optical imaging system of claim 1, wherein the first lens and the second lens are D-cut lenses.

4. The optical imaging system of claim 1, wherein the fifth lens has a convex image-side surface in a paraxial region thereof, and the sixth lens has a convex object-side surface in a paraxial region thereof.

5. The optical imaging system of claim 1, wherein the following conditional expression is satisfied:
$$100 \leq ( v 1 + v 3 ) \leq 120$$
where v1 is an Abbe number of the first lens, and v3 is an Abbe number of the third lens.

6. The optical imaging system of claim 1, wherein the following conditional expression is satisfied:
$$0.8 \leq R 1 / R 5 \leq 1.2$$
where R1 is a radius of curvature of the object-side surface of the first lens at the optical axis, and R5 is a radius of curvature of an object-side surface of the third lens at the optical axis.

7. The optical imaging system of claim 1, wherein the following conditional expression is satisfied:
$$0.2 < IMG HT / EPD \leq 0.4$$
where IMG HT is one half of a diagonal length of the imaging plane, and EPD is a diameter of an entrance pupil of the optical imaging system.

8. The optical imaging system of claim 1, wherein the following conditional expression is satisfied:
$$0.2 \leq ( CT 1 + CT 2 + CT 3 + CT 4 ) / f \leq 0.5$$
where CT1 is a thickness of the first lens along the optical axis, CT2 is a thickness of the second lens along the optical axis, CT3 is a thickness of the third lens along the optical axis, and CT4 is a thickness of the fourth lens along the optical axis.

9. The optical imaging system of claim 1, wherein the following conditional expression is satisfied:
$$0.2 \leq D 45 / Td \leq 0.4$$
where D45 is a distance along the optical axis from an image-side surface of the fourth lens to an object-side surface of the fifth lens and Td is a distance along the optical axis from the object-side surface of the first lens to an image-side surface of the sixth lens.

10. The optical imaging system of claim 1, wherein the first lens is a D-cut lens having a major axis and a minor axis perpendicular to the major axis, and
the following conditional expression is satisfied:
$$0.5 < AR 1 < 1.$$
where AR1 is equal to a maximum effective radius of an object-side surface of the D-cut lens along the major axis of the D-cut lens to a radius of the object-side surface of the D-cut lens along the minor axis of the D-cut lens.

11. The optical imaging system of claim 1, wherein the following conditional expression is satisfied:
$$0.3 < \sum CT / TTL < 0.5$$
where ECT is a sum of thicknesses the first to sixth lenses along the optical axis.

12. The optical imaging system of claim 1, wherein the following conditional expression is satisfied:
$$- 1. V f 1 / f 2 < 0$$
where f2 is a focal length of the second lens.

13. An optical imaging system comprising:
a first lens having a refractive power, a second lens having a refractive power, a third lens having a positive refractive power and a concave image-side surface in a paraxial region thereof, a fourth lens having a negative refractive power and a convex object-side surface in a paraxial region thereof, a fifth lens having a refractive power, and a sixth lens having a convex object-side surface in a paraxial region thereof sequentially disposed in ascending numerical order along an optical axis of the optical imaging system from an object side of the optical imaging system toward an imaging plane of the optical imaging system,
wherein the following conditional expressions are satisfied:
$$1.7 < f - number < 2.$$
$$0.2 < IMG HT / EPD \leq 0.4$$
where f-number is an f-number of the optical imaging system, IMG HT is one half of a diagonal length of the imaging plane, and EPD is a diameter of an entrance pupil of the optical imaging system.

14. The optical imaging system of claim 13, wherein the first to the sixth lenses are spaced apart from each other by respective distances along the optical axis, and a distance between the fourth lens and the fifth lens along the optical axis is greater than each of a distance between the first lens and the second lens along the optical axis, a distance between the second lens and the third lens along the optical axis, a distance between the third lens and the fourth lens along the optical axis, and a distance between the fifth lens and the sixth lens along the optical axis.

15. The optical imaging system of claim 13, wherein the following conditional expression is satisfied:
$$0.2 \leq D 45 / Td \leq 0.4$$
where D45 is a distance along the optical axis from an image-side surface of the fourth lens to an object-side surface of the fifth lens, and Td is a distance along the optical axis from an object-side surface of the first lens to an image-side surface of the sixth lens.

16. The optical imaging system of claim 13, wherein the following conditional expression is satisfied:
$$0.8 \leq R 1 / R 5 \leq 1.2$$
where R1 is a radius of curvature of an object-side surface of the first lens at the optical axis, and R5 is a radius of curvature of an object-side surface of the third lens at the optical axis.

17. The optical imaging system of claim 13, wherein the following conditional expression is satisfied:
$$0.2 \leq ( CT 1 + CT 2 + CT 3 + CT 4 ) / f \leq 0.5$$
where CT1 is a thickness of the first lens along the optical axis, CT2 is a thickness of the second lens along the optical axis, CT3 is a thickness of the third lens along the optical axis, CT4 is a thickness of the fourth lens along the optical axis, and f is a total focal length of the optical imaging system.

18. The optical imaging system of claim 13, further comprising an optical path changing member for changing a path of light disposed on an object side of the first lens,
wherein one or more of the first lens to the sixth lens is a D-cut lens.

19. The optical imaging system of claim 13, wherein the fifth lens has a positive refractive power, and the sixth lens has a negative refractive power.

20. The optical imaging system of claim 13, wherein the first lens is a D-cut lens having a major axis and a minor axis perpendicular to the major axis, and
the following conditional expression is satisfied:
$$0.5 < AR 1 < 1.$$
where AR1 is equal to a maximum effective radius of an object-side surface of the D-cut lens along the major axis of the D-cut lens to a radius of the object-side surface of the D-cut lens along the minor axis of the D-cut lens.
